(19) United States
(12) Patent Application Publication
(10) Pub. No.: US 2014/0141854 A1
(43) Pub. Date: May 22, 2014

(54) Method for playing a poker game featuring dealer play and no folding of cards by the players

(71) Applicant: Gregory Sholes, Vernon, NJ (US)

(72) Inventor: Gregory Sholes, Vernon, NJ (US)

(21) Appl. No.: 13/694,311

(22) Filed: Nov. 19, 2012

(51) Int. Cl. A63F 1/00; A63F 13/00

(52) U.S. Cl. CPC A63F 1/00; A63F 13/005
USPC 463/13; 273/303

(57) ABSTRACT

A method for playing a poker game involving a plurality of players and a dealer, said method comprising the steps of: each player wagering the same amount to create a pot amount; dealing a first card face-down to each player and to the dealer; dealing a second card face-down to each player and to the dealer; dealing a first burn card face-down; dealing three community cards face-up; dealing a second burn card face-down; dealing a fourth community card face-up; dealing a third burn card face-down; dealing a fifth community card face-up; exposing each players' and the dealer's two cards; determining the best poker hands made by each player's two cards and made by the dealer's two cards in combination with the five face-up community cards; and paying or crediting the net pot amount to the player who makes the best poker hand being higher than the dealer's best poker hand.

### RELATED APPLICATION

This is a continuation-in-part application of: co-pending application having Ser. No. 12/802,853 and filing date Jun. 16, 2610, and being entitled “Method For Playing A Poker Game Featuring Dealer Play And No Folding Of Cards By The Players”.

### BACKGROUND OF THE INVENTION

1. Field of the Invention

This invention relates to an Improved Method For Playing A Poker Game and in particular to a poker game involving dealer play and no folding of cards by the players.

2. Description of the Prior Art

The prior art discloses the following:
1. Aramapakul et al U.S. Pat. No. 5,718,430, issued on Feb. 17, 1998, and entitled “METHOD FOR PLAYING A CARD GAME”, discloses:

“A poker type card game. First, each player bets. Then three cards are dealt face down to each player. Each player discards one card, keeping two. Then five community cards are dealt face up as common cards. Each player makes a five card poker hand from any combination of his two hole cards and the common cards. Alternatives require that one only, or one or two of the hole cards be used.”

“A method of playing a poker game, in which one player is selected as a player-bank comprising the steps of; the player-banker wagering a desired amount designated as the bank amount; the other players wagering desired amounts each; dealing three hole cards to each player; each player discarding one of the three hole cards; dealing five community cards face up as common cards; each player in turn, from a predetermined first player resolving his wager with the player-bank based on poker hand priority by selecting the best five card hand of the seven cards consisting of the player's two hole cards and the five common cards; and wherein a higher hand wins over the player-bank and otherwise the player-bank wins.”

“A method of playing a poker game in which the players play against each other for a single winner comprising the steps of: each player wagers an equal predetermined amount dealing three hole cards to each player; each player discarding one of the three hole cards; dealing five community cards face up as common cards; each player setting a five card poker hand from any combination of the seven cards consisting of the two hole cards and the five common cards; and resolving wagers by poker hand priority rules.”

“A method of playing a poker game comprising; each player wagering; dealing three hole cards to each player; each player discarding one of the three hole cards; dealing five community cards face up as common cards; each player setting a five card hand from any combination of the seven cards consisting of the two remaining hole cards and the five common cards; and resolving wagers by poker hand priority rules.”
2. McInerney U.S. Pat. No. 6,517,072, issued on Feb. 11, 2003, and entitled “CASINO TABLE CARD GAME”, discloses:

“A playing card, wagering game method where each player antes one unit. The dealer will deal four cards down to each player and four cards down to himself. Each player evaluates their hand and elects to either fold or challenge the remaining players and dealer. Any player who folds, surrenders his ante to the house. The total amount of antes remaining after each player evaluates his hand will be referred to as the “ante pot”. All players electing to remain, or challenge, (including the dealer), must wager an amount equal to the ante pot. The dealer always challenges the pot. After each player has elected to either fold or challenge, the dealer, after “burning” a card, will deal or “flop” another three community cards to be used by all challenging participants. The highest poker hand of each participant using their initial four cards plus the three community cards wins the pot. The first player to act is determined on a rotating basis to eliminate position advantage. Single player versus the dealer has the option to double the “ante pot,” resulting in the dealer likewise adding to the ante pot.”

“A method of playing a wagering game with a single, typical fifty-two card poker deck, the cards having a standard rank in value, said game, when played, providing for the evaluation of cards in pairs and straights equivalent to a standard game of poker, comprising the steps of: each player in the wagering game anteing one unit of betting to participate in the game; the dealer deals the same number of a plurality of cards face down to each player in the game and to himself, the cards the dealer initially deals to each player face down is four; each player evaluates his/her hand and elects to fold or challenge the remaining players and the dealer, the player who folds surrenders his/her previous ante, and the dealer then accumulates all antes into an ante pot; any player who folds surrenders his/her initial ante to the dealer; each player electing to challenge the dealer must contribute to match the entire ante pot to remain in the wagering game; the dealer likewise contributes to match the ante pot; the dealer thereafter deals a series of additional community cards face up which can be used by the remaining players, and the dealer, to determine a winner based upon the highest ranking poker hand in the game, the community cards the dealer deals during playing of the game is three; thereafter the dealer reads all hands and declares who is the winner of the wagering game.”

“A method of playing a wagering card game for a number of players using the standard playing cards, said game involving standard poker hand rankings, and comprising the steps of: each player participating in the wagering game placing a wager to participate in the game; a dealer dealing four cards down to each player, and four cards down to the dealer; providing each player with the opportunity to examine his/her cards received by that player, and thereafter electing to fold or remove from the game, or challenge the competing players and the dealer; each player challenging must wager an amount equal to the ante accumulated pot which is determined by the remaining players challenging, and wherein the dealer must match the ante pot; the dealer must remain in the game and cannot fold; any player who folds surrenders his/her ante to the house; the dealer must challenge every hand regardless of the strength of the dealer's hand; the first player to act is determined on a rotating basis to eliminate position advantage; the dealer after burning the top card of the deck will deal or flop three community cards which the players and dealer will use to make the highest ranking poker hand possible, along with their four initial cards; and whereby the highest ranking poker hand wins the ante pot, as matched.”
3. Snow published patent application number 2006-0284376, published on Dec. 21, 2006, and entitled “CASINO TABLE VARIANT OF TEXAS HOLD'EM POKER”, discloses:

“A variant game of Hold'Em poker allows for rules of play of one or all of Players being allowed to remain in game with an option of checking or making specific wagering amounts in first Play wagers, being limited in the size of subsequent available Play wagers or prohibited from making additional Play wagers if a first Play wager has been made, being limited in the size of available later Play wagers if a first or earlier Play wager has been made, and having the opportunity for at least two and as many as three or four distinct opportunities in the stages in the play of hand to be able to make one or more Play wagers.”

“A method of playing a wagering game using poker rankings wherein a player places at least an Ante wager prior to seeing any cards in play of a hand of the wagering game and is provided with an opportunity to make at least one additional play wager comprising at least one of a first play wager and a second play wager in the game subsequent to the Ante wager and after seeing at least a first one card in the play of the wagering game, wherein when a player elects to make a first play wager or not make the first play wager, that election changes options available to the player on the second play wager.”

“A method of playing a wagering game, comprising: A player placing at least an Ante wager to participate in the game; A dealer dealing at least one card to each player and at least one card to the dealer, each at least one card forming a partial hand; A dealer dealing at least one community card; Wherein after each player views the at least one card, the player either checks or makes a first Play wager that is a multiple of the amount of the Ante, at the option of the player; The dealer revealing at least one community card; and The players making a play bet that is less than a maximum allowable multiple of the first play bet if the player has not previously made the first Play bet or checking; and Paying the players whose poker hand rankings exceed the dealer hand ranking.”

“An interactive video gaming platform for multiple players, comprising: Multiple player stations; A first common video display area that displays game play, including cards and wagers; A second video display area displaying a video representation of a dealer; Wherein each player station is equipped with controls and the platform is programmed to execute a game, wherein the game rules include the steps of: Each player placing an Ante to participate in the game; Each player and the dealer receiving at least one card and at least one card is dealt face-down as common cards; After viewing the at least one player card, each player having an option to place a play wager that is a multiple of the Ante; Revealing at least one common card; wherein players who have not previously made a play wager either make a play wager that is a smaller multiple then a maximum multiple of the Ante of the first Play wager, or check.”
4. Feola published patent application number 2007-0176364, published on Aug. 2, 2007, and entitled “METHOD OF PLAYING A BONUS WAGER FOR A HOLD'EM-TYPE POKER GAME”, discloses:

“A method of playing a bonus for a Hold'em-type poker game wherein at least one card is dealt to each player hand and at least one card is dealt as community cards. A player wagering on the bonus wins if a subset of the community cards has a predetermined combination. Preferably, there are five community cards. In one embodiment, the bonus is determined from three of the community cards. In another embodiment, the bonus is determined from all five community cards.”

“A method of playing a bonus for a poker-type game with at least one 52-card deck of playing cards, said method comprising the following steps: (a) at least one player wagering on said bonus; (b) dealing at least one playing card to a plurality of hands; (c) dealing at least one playing card as community cards; (d) forming a bonus hand from a subset of said community cards; and (e) paying said at least one player a predetermined amount if said bonus hand has a predetermined combination of playing cards.”

“A method of playing a bonus for a poker-type game with at least one 52-card deck of playing cards, said method comprising the following steps: (a) at least one player wagering on said bonus; (b) dealing two playing cards to a plurality of hands; (c) dealing five playing cards as community cards; (d) forming a bonus hand from a subset of said community cards; and (e) paying said at least one player a predetermined amount if said bonus hand has a predetermined combination of playing cards.”
5. Webb published patent application number 2007-0216097, published on Sep. 20, 2007, and entitled “HOLD'EM TABLE GAME”, discloses:

“A method of playing a house-banked casino card game includes dealing player cards to a player, dealer cards to a dealer, and community cards to form a player hand and a dealer hand. The players are provided with options to place wagers, wherein a number of placed wagers in play is determined according to a rank of the dealer hand. Moreover, not all wagers are required for the player to stay in the game.”

“A method of playing a house-banked casino card game, the method comprising: (a) receiving an Ante wager from a player; (b) dealing at least one player card to the player and at least one dealer card to a dealer; (c) providing the player with an option to place a Play wager, wherein the Play wager is not required for the player to stay in the game; (d) dealing at least one community card, wherein a player hand includes cards selected from the at least one player card and the at least one community card, and wherein the dealer hand includes cards selected from the at least one dealer card and the at least one community card; and (e) resolving the Ante wager and the Play wager if placed according to a rank of the player hand versus a rank of the dealer hand.”

“A method of playing a house-banked casino card game, the method comprising: (a) receiving an Ante wager from a player; (b) dealing at least one player card to the player and at least one dealer card to a dealer; (c) alternately providing the player with an option to place a subsequent wager and dealing at least one community card; (d) repeating step (c) until a predetermined number of wager options have been provided to the player and a predetermined number of community cards have been dealt, wherein a player hand includes cards selected from the at least one player card and at least one of the predetermined number of community cards, and wherein the dealer hand includes cards selected from the at least one dealer card and at least one of the predetermined number of community cards; and (e) resolving the Ante wager and all subsequent wagers according to a rank of the player hand versus a rank of the dealer hand, wherein the number of the subsequent wagers in play is determined according to the rank of the dealer hand.”

“A method of playing a house banked casino card game, the method comprising: (a) receiving an Ante wager from a player; (b) dealing two player cards to the player and two dealer cards to a dealer; (c) providing the player with an option to place a Play wager, wherein the Play wager is not required for the player to stay in the game; (d) dealing first, second and third community cards; (e) providing the player with an option to place a Flop wager, wherein the Flop wager is not required for the player to stay in the game; (f) dealing a fourth community card; (g) providing the player with an option to place a Turn wager, wherein the Turn wager is not required for the player to stay in the game; (h) dealing a fifth community card, wherein a player hand consists of five community cards selected from the two player cards and the first through fifth community cards, and wherein the dealer hand consists of five community cards selected from the two dealer cards and the first through fifth community card; (i) providing the player with an option to place a River wager, wherein the River wager is not required for the player to stay in the game; (j) determining which of the Play wager, the Flop wager, the Turn wager and the River wager are in play based on a poker rank of the dealer hand; and (k) resolving the Ante wager, the Play wager, the Flop wager, the Turn wager and the River wager if placed according to which of the wagers are in play based on a poker rank of the player hand versus a poker rank of the dealer hand.”

“A method of playing a house-banked casino card game comprising dealing player cards to a player, dealer cards to a dealer, and community cards to form a player hand and a dealer hand, and providing the player with options to place wagers, wherein a number of placed wagers in play is determined according to a rank of the dealer hand.”

“A method of playing a house-banked casino card game comprising dealing player cards to a player, dealer cards to a dealer, and community cards to form a player hand and a dealer hand, and providing the player with options to place wagers, wherein only one wager is required for the player to stay in the game.”
5. Webb published patent application number 2007-0216099, published on Sep. 20, 2007, and entitled “HOLD'EM TABLE GAME”, discloses:

“A method of playing a house-banked casino card game includes dealing player cards to a player, dealer cards to a dealer, and community cards to form a player hand and a dealer hand. After initial wagers, the players are provided with options to place additional wagers, which are not required to stay in the game. Competition wagers are resolved based on a comparison of the dealer hand and the player hand, and a proposition wager is resolved based on either the player hand or the dealer, or possibly the better of the two, against a payout scale.”

“A method of playing a house-banked casino card game, the method comprising: (a) receiving an Ante wager, a Blind wager, and a Two-Way wager from a player; (b) dealing two player cards to the player and two dealer cards to a dealer; (c) dealing three community cards to a center card area; (d) after step (c), providing the player with an option to place a Flop wager, wherein the Flop wager is not required for the player to stay in the game; (e) after step (d), dealing two additional community cards; (f) after step (e), providing the player with an option to place a River wager, wherein the River wager is not required for the player to stay in the game, wherein a player hand includes cards selected from the player cards, the three community cards, and the two additional community cards, and wherein the dealer hand includes cards selected from the dealer cards, the three community cards, and the two additional community cards; (g) resolving the Ante wager, the Blind wager, and if placed, the Flop wager and the River wager according to a poker rank of the player hand versus a poker rank of the dealer hand; and (h) resolving the Two-Way wager according to the poker rank of one of the player hand or the dealer hand against a scale.”

“A method of playing a house-banked casino card game, the method comprising: (a) receiving at least a competition wager and a proposition wager from a player; (b) dealing player cards to the player and dealer cards to a dealer; (c) dealing at least one community card to a center card area; (d) after step (c), providing the player with a first option to increase the competition wager; (e) after step (d), dealing at least one additional community card; (f) after step (e), providing the player with a second option to increase the competition wager, wherein a player hand includes cards selected from the player cards, the at least one community card, and the at least one additional community card, and wherein the dealer hand includes cards selected from the dealer cards, the at least one community card, and the at least one additional community card; (g) resolving the competition wager according to a poker rank of the player hand versus a poker rank of the dealer hand; and (h) resolving the proposition wager according to the poker rank of one of the player hand or the dealer hand against a scale.”

“A method of playing a house-banked casino Texas Hold'Em card game, the method comprising: (a) receiving compulsory wagers from each player; (b) dealing two cards to each player and a dealer in rotation; (c) dealing five community cards in a Flop round and a River round; (d) providing additional wagering options after the Flop round and after the River round, wherein no additional wagers are required for the players to stay in the game; and (e) resolving the compulsory wagers and any additional wagers according to game rules, wherein all against dealer wagers in play give 1 to 1 symmetrical action.”
6. Davis et al published patent application number 2008/0007003, published Jan. 10, 2008, and entitled “METHOD FOR PLAYING A POKER-TYPE GAME”, discloses:

“There is provided a method of playing a poker-type game amongst a large number of players located at remote locations. The method includes the steps of dividing a standard 52-card deck into a reserve and a player deck, so that the reserve contains 16 randomly selected cards and the player deck contains the remaining 36 cards. Each player is then provided with a ticket showing two randomly selected cards from the player deck. Fictitious opponents are each provided with two randomly selected cards from the reserve, while five randomly selected cards from the reserve are used to form the community cards. As in Texas Hold'Em poker, the best 5-card poker hand for each player and each fictitious opponent is determined from amongst the two cards the 5 community cards. Two categories of prizes are awarded. The first to players whose hands beat all fictitious opponents. If no player beats all fictitious opponents, then the second prize goes to the players with the best hands amongst all players participating in the game. Optionally, there may also be a “Bad Beat Jackpot” for certain exceptionally good hands that do not beat all fictitious opponents. There is also provided an apparatus for carrying out this method.”

“A method of playing a poker-type game amongst a large number of players, the method comprising the steps of: (a) dividing a standard 52-card deck into a reserve and a player deck, wherein the reserve contains 16 randomly selected cards and the player deck contains the remaining 36 cards, (b) providing each player with a ticket showing two randomly selected cards from the player deck, (c) creating fictitious opponents who are each provided with two randomly selected cards from the reserve, (d) exposing five randomly selected cards from the reserve to form the community cards, (e) determining the best 5-card hand for each player amongst the two cards on the player's ticket and the 5 community cards, (f) determining the best 5-card poker hand for each fictitious opponent amongst the opponent's two cards and the 5 community cards, (g) comparing each player's best 5-card poker hand with the best 5-card poker hand of each fictitious opponent to determine which of the players has a best 5-card poker hand that beats the best 5-card poker hand of all fictitious opponents, and (h) declaring each player that beats all fictitious opponents as a first prize winner.”

“An apparatus allowing a large number of players to play a poker-type game, comprising: (a) a central computer system, (b) a plurality of remotely located terminals, (c) a plurality of remotely located display devices, and (d) means for causing data to be communicated between the central computer system, the terminals and the display devices, wherein the central computer system comprises means for: i) dividing a standard 52-card deck into a reserve and a player deck, wherein the reserve contains 16 randomly selected cards and the player deck contains the remaining 36 cards, ii) generating for each player a ticket showing two randomly selected cards from the player deck, iii) creating fictitious opponents who are each provided with two randomly selected cards from the reserve, iv) using five randomly selected cards from the reserve to form the community cards, v) determining the best 5-card hand for each player amongst the two cards on the player's ticket and the 5 community cards, vi) determining the best 5-card poker hand for each fictitious opponent amongst the opponent's two cards and the 5 community cards, vii) comparing each player's best 5-card poker hand with the best 5-card poker hand of each fictitious opponent to determine which of the players has a best 5-card poker hand that beats the best 5-card poker hand of all fictitious opponents, and viii) declaring each player that beats all fictitious opponents as a first prize winner.”

7. Colacone published patent application number 2009/0020951, published Jan. 22, 2009, and entitled “ONE BET POKER”, discloses:

“A method of playing a poker game comprises: each player making one bet (“Showdown bet”) and an optional side bet; dealing two face up cards to each player and to the dealer; dealing five community cards face up; each player and the dealer forming their best five-card poker hand comprised of any five community cards selected from the two face up cards dealt to them and the five community cards; comparing each player's hand and the dealer's hand; resolving Showdown bets wherein a player is paid even money on the player's Showdown bet if the player's hand beats the dealer's hand; and resolving side bets wherein a player's side bet wins if the player's hand is comprised of a predetermined poker combination. In one embodiment of the invention, the predetermined poker combination may be a Royal Flush, Straight Flush, Four-of-a-Kind, Full House, Flush, Straight, Three-of-a-Kind, or Jacks-High Two Pair.”

“A method of playing a poker game between a dealer and at least one player, the method comprising: (a) each player making one bet; (b) dealing two cards face up to each player and to the dealer; (c) dealing five community cards face up; (d) each player forming a player hand comprised of player's best five community cards, wherein the player's best five community cards are selected from the two cards dealt to the player and the community cards; (e) the dealer forming a dealer hand comprised of dealer's best five community cards, wherein the dealer's best five community cards are selected from the two cards dealt to the dealer and the community cards; (f) comparing each player hand with the dealer hand; and (g) resolving each player's one bet.”

“A method of playing a poker game between a dealer and at least one player, the method comprising: (a) requiring each player to make one bet; (b) allowing each player to optionally make a side bet; (c) dealing two player cards face up to each player; (d) dealing two dealer cards face up to the dealer; (e) dealing five community cards face up; (f) each player forming a player hand comprised of player's best five community cards, wherein the player's best five community cards are selected from the player cards and the community cards; (g) the dealer forming a dealer hand comprised of dealer's best five community cards, wherein the dealer's best five community cards are selected from the dealer cards and the community cards; (h) comparing each player hand with the dealer hand using traditional poker rankings; (i) resolving the one bet wherein the one bet is paid even money if the player hand is higher than the dealer hand and the one bet is lost if the player hand is lower than or ties with the dealer hand; and (j) resolving the side bet wherein the side bet wins if the player hand is comprised of a predetermined poker combination.”

“A method of playing a poker game between a dealer and at least one player, the method comprising: (a) requiring each player to make one bet; (b) allowing each player to optionally make a side bet; (c) dealing two player cards face up to each player; (d) dealing two dealer cards face up to the dealer; (e) dealing a first community card, a second community card, a third community card, a fourth community card, and a fifth community card face up; (f) having each player form a player hand comprised of player's best five community cards, wherein the player's best five community cards are selected from the two player cards, the n first community card, the second community card, the third community card, the fourth community card, and the fifth community card; (g) having the dealer form a dealer hand comprised of dealer's best five community cards, wherein the dealer's best five community cards are selected from the two dealer cards, the first community card, the second community card, the third community card, the fourth community card, and the fifth community card; (h) comparing each player hand with the dealer hand using traditional poker rankings; (i) resolving the one bet by paying even money on the one bet if the player hand is higher than the dealer hand and by collecting the one bet if the player hand is lower than or ties with the dealer hand; and (j) resolving the side bet wherein the side wins if the player hand is comprised of a Royal Flush, Straight Flush, Four-of-a-Kind, Full House, Flush, Straight, Three-of-a-Kind, or Jacks-High Two Pair.”

It will be apparent to those skilled in the art that Applicant's claimed invention is not disclosed by the above-cited references. In Applicant's claimed invention should the dealer make the best poker hand higher than all of the best poker hands made by the players then the dealer is paid or credited only one-half of all the players' original bet amounts and each player is paid or credited one-half of each player's original bet amount. Also, in Applicant's claimed invention should a player make the best poker hand higher than all of the poker hands made by the other players and better than the best poker hand made by the dealer then the player who makes the best poker hand is paid or credited all of the players' original bet amounts minus the house rake and minus any jackpot rake.

Objects of the present invention are to provide:

A poker game that is easy to learn;

A poker game that is easy to play;

A poker game that does not require strategy;

A poker game that is attractive to players with no poker skills;

A poker game that provides for bonus, bad-beat jackpot and super bad-beat jackpot payouts;

A poker game that allows for social interaction;

A poker game that allows for many poker hands per hour;

A poker game that allows for increased casino revenue.

A poker game that involves dealer play and no folding of hands by the players.

### Features Of The Present Invention

According to one embodiment of the present invention, a method for playing a poker game with a standard 52 card deck, said method involving a plurality N of players and a dealer, said method comprising the steps of: each player wagering the same amount to create a pot amount; dealing a first card face-down to each player and to the dealer; dealing a second card face-down to each player and to the dealer; dealing a first burn card face-down; dealing three community cards face-up; dealing a second burn card face-down; dealing a fourth community card face-up; dealing a third burn card face-down; dealing a fifth community card face-up; the aforementioned steps effecting a transformation of the 52 card deck to a card deck comprising 52-(N+1)-(N+1)-1-3-1-1-1-1 cards; exposing each players' two cards and the dealer's two cards; determining the best poker hand made by each player's two cards and the best poker hand made by the dealer's two cards in combination with the five face-up community cards; and paying or crediting the pot amount minus the house rake amount and minus the jackpot rake amount if any to the player who makes the best poker hand being higher than the dealer's best poker hand.

Features of the present invention are therefore that:

In Applicant's claimed invention should the dealer make the best poker hand higher than the best poker hands made by the players then the dealer being paid or credited only one-half of the players' original bet amounts and each player being paid or credited one-half of each player's original bet amount.

In Applicant's claimed invention should a player make the best poker hand higher than all of the poker hands made by the other players and higher than the best poker hand made by the dealer then the player who makes the best poker hand is paid or credited all of the players' original bet amounts minus the house rake amount and minus the jackpot rake amount if any.

The dealer and the players are each dealt the same number of cards.

One-half of the original pot amount is paid or credited to the players whenever the dealer makes the best poker hand.

The poker game allows for the payment of bonuses, bad-beat jackpot amounts, and super bad-beat jackpot amounts to the players.

The poker game may be played on a physical poker table with a live dealer shuffling and dealing cards from a standard 52 card deck.

The poker game may be played on a physical poker table including an automatic card shuffling machine for shuffling a standard 52 card deck for dealing by a live dealer.

The poker game may be played on a physical poker table including one electronic monitor assigned to each live player for controllably displaying or not displaying the player's cards, one electronic monitor assigned to the live dealer for controllably displaying or not displaying the dealer's cards, and one common electronic monitor for controllably displaying the five community cards face-up in order.

The poker game may be played on a server-computer-controlled online internet network wherein each of N remote players is assigned a touch-responsive electronic monitor device at his remote location, said server-computer effecting display or non-display of all the players' two cards, the virtual dealer's two cards, and the five community cards face-up.

### BRIEF DESCRIPTION OF THE DRAWINGS

The above and other objects, advantages and features of the present invention will be further appreciated from a reading of the following detailed description in conjunction with the drawing in which:

FIGS. 1 through 5 are top views of poker table 20 showing how a traditional limit Texas Holdem poker hand is played.

FIGS. 6 through 8 are top views of poker table 100 showing how the two hole-cards are dealt in the limit Texas Holdem poker hand according to the present invention.

FIGS. 9 through 11 are top views of poker table 100 showing how the five common cards are dealt in the limit Texas Holdem poker hand according to the present invention.

FIG. 12 is a top view of poker table 100 showing the various designated regions of the table according to the present invention.

FIG. 13 is a top view of poker table 100 showing the various designated regions of the table featuring optional bonus betting according to the present invention.

FIG. 14 shows the standard 52 card deck before dealing applicant's game.

FIG. 15 shows the transformed deck of cards after respectively dealing first cards C11-C18 to players P1-P8 and first card C19 to dealer D.

FIG. 16 shows the transformed deck of cards after respectively dealing second cards C21-C28 to players P1-P8 and second card C29 to dealer D.

FIG. 17 shows the transformed deck of cards after dealing or discarding first burn card B1.

FIG. 18 shows the transformed deck of cards after dealing and revealing three flop cards F1-F2-F3.

FIG. 19 shows the transformed deck of cards after dealing or discarding second burn card B2.

FIG. 20 shows the transformed deck of cards after dealing and revealing turn card T.

FIG. 21 shows the transformed deck of cards after dealing or discarding third burn card B3.

FIG. 22 shows the transformed deck of cards after dealing and revealing river card R.

FIG. 23 shows the final transformed deck of cards revealing only the remaining cards after dealing out river card R.

FIG. 24 shows computerized table 150.

FIG. 25 shows online network gaming system 200.

### DETAILED DESCRIPTION OF THE INVENTION

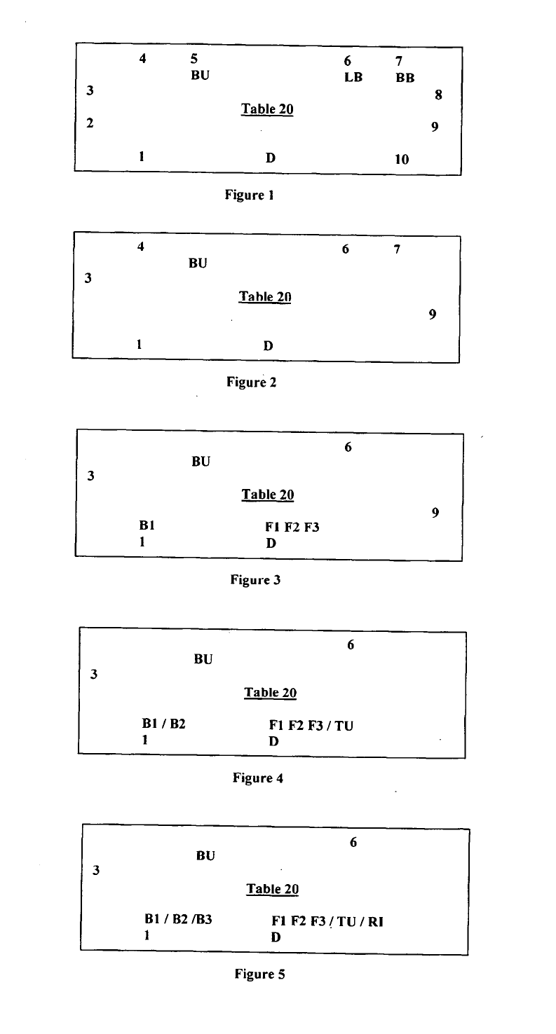

FIGS. 1 Through 5

FIGS. 1 through 5 are top views of poker table 20 showing how a limit Holdem poker hand may be played. Generally, a Limit Holdem Poker Game is played by up to 10 players on an oval-shaped poker table. The Dealer sits in the middle of one of the long sides of the table. The betting limits are set by the casino. The most popular Holdem limits are: $5/$10; $10/$20; $15/$30; $20/$40; $30/$60; and $50/$100. The first $ amount is the “big blind” amount. In $10/$20 limit Holdem, the big blind is $10. The “little blind” amount is $5. During the 1st and 2nd betting rounds of a poker hand, the defined bet is $10 plus up to a possible 3 raises for a total maximum bet of $40. During the 3rd and 4th betting rounds, the defined bet is $20 plus up to a possible 3 raises for a total maximum bet of $80.

The following detailed description relates to a $10/$20 limit Holdem game. Each hand of limit Holdem involves several steps taken by the Dealer and up to four betting rounds effected by the players. The order of dealing by the Dealer and the order of betting by the players are controlled by the designated player position called the “button”. The player who is the button is designated by a round white plastic button which is physically placed in front of that player so that the Dealer and all the other players know which player is the button.

In $10/$20 limit Holdem, each player initially buys poker chips for no less than the minimum amount set by the casino (such as $100) and up to $1,000 or more at the discretion of the player or at the discretion of the casino. Each player now has a stack of chips for playing each hand of poker. Before the beginning of play (before the first hand is dealt and played), the Dealer deals each player one card face-up in clockwise order starting with the first player to the left of the dealer. The player who is dealt the highest-ranking card face-up is designated the button for the first hand. The plastic button is then physically placed in front of that player who was dealt the highest ranking card face-up.

There are two ways by which the casino (“the house”) makes money from a poker game. In high limit Holdem, the casino usually charges each player at the table a monetary amount (“time”) during each ½ hour. For example, in $10/$20 limit Holdem, the time amount charged each player each ½ hour may be $5. In low limit Holdem, the casino usually takes an amount (“the rake”) being a certain maximum percentage from each pot at the end of each completed poker hand. For example, in $5/$10 limit Holdem, the rake may be up to a maximum of $4.

The wager options or the wager actions that a player may choose from are fold, check, call, bet or raise.

Fold means that a player does not want to meet the pending bet or raised amount. Such player surrenders his two hole-cards; and such player surrenders whatever moneys he has wagered so far up to that betting round of the poker hand.

Check means that a player does not want to bet when there is no pending bet or no pending raise amount.

Call means that a player puts into the pot the same amount as the pending bet or raised amount.

Bet means that a player bets the amount allowed during that betting round. Such bet amount may be the big blind amount or double the big blind amount depending on the betting round.

Raise means that a player bets an amount greater than the pending bet or pending raises amount. Such raise amount may be a multiple of the big blind amount or a multiple of double the big blind amount allowed during that betting round.

Side pots are created as follows. A player must either fold, check, call, bet, or raise. Such player has a certain number of chips in front of him at that time of play. If such player is not able to call the whole pending bet amount or pending raises amount; or if such player is not able to make a whole bet; or if such player is not able to make a whole raise, then the dealer creates a side pot in addition to the already existing main pot. The dealer determines the reduced amount that such player can call, bet or raise. Then the dealer places that amount into the main pot times the number of active players still remaining in the hand at that time. For example, if the all-in player has only $5 and there are 4 active players in the hand, then the dealer places $20 into the main pot. The dealer then creates the side pot from the difference that the other 3 active players further call, bet or raise. The all-in player can only win the main pot. The other 3 active players can win the main pot and/or the side pot.

Now refer to FIGS. 1 through 5 which are top views of poker table 20 showing how a limit Holdem poker hand may be played. See FIG. 1. Table 20 is shown as viewed from above. The positions of Dealer D and of players 1-10 are shown. For explanatory purposes only, it is assumed that player 5 was dealt the highest-ranking card face-up and is therefor designated the button BU for the first hand. Therefore, round white plastic button BU is physically placed in front of player 5. Before any hand of limit Holdem is played, the most important questions asked by dealer D and by all the players at the table are: Which player is the button BU? Which player is the little blind LB? Which player is the big blind BB? In this example, player 5 is the dealer button BU. Player 6 is the little blind LB and places a $5 chip on the table in front of him before the first hand is dealt. Player 7 is the big blind BB and places a $10 chip on the table in front of him before the first hand is dealt.

Dealer D now knows that player 5 is the button. Dealing and betting by players 1-10 are performed in a clock-wise manner relative to player 5 who is button BU. Each hand of limit Holdem comprises up to four betting rounds. The 1st betting round is called the pre-flop betting round; the 2nd betting round is called the post-flop betting round; the 3rd betting round is called the post-turn betting round; and the 4th betting round is called the post-river betting round. Button BU remains in place throughout all betting rounds of a poker hand. Before the pre-flop betting round, player 6 (who is the little blind LB) must place a $5 chip in front of him. Player 7 (who is the big blind BB) must place a $10 chip in front of him. Players 6 and 7 have not yet been dealt any cards by dealer D. Dealer D now deals player 6 one hole-card facedown; player 7 one hole-card face-down; and so on until player (button BU) is dealt one hole-card face-down. Dealer D next deals each player a second hole-card face-down in the same clockwise order as before. Player 8 now has three options: he may call the big blind amount of $10; he may raise by the big blind amount and make the bet $20; or he may drop out of the hand and fold by surrendering his two cards to dealer D. After player 8 exercises one of his options, then it is up to player 9 to exercise one of his options, and so on until player 5 (button BU) exercises one of his options. Player 6 (the little blind LB who has already placed a $5 chip in front of him) may now exercise one of the following options. He may complete his bet to $10 by placing a second $5 chip in front of him if no one before him has raised to $20 or higher. He may call a higher bet if there was at least one raise before him. He may drop out and fold his hand by surrendering his two cards and his $5 chip. If player 6 still has an option to raise and in fact does raise, then all subsequent remaining players must either meet his raise or must fold their hands. Player 7 (the big blind BB who has already placed a $10 chip in front of him) may now exercise one of the following options. He may call if no one has raised before him by pushing his $10 chip forward. He may call a higher bet if there was at least one raise before him. He may drop out of the hand and fold by surrendering his two cards and his $10 chip if there was at least one raise before him. If player 7 still has an option to raise and in fact does raise, then all subsequent remaining players must either meet his raise or must fold their hands. The maximum number of raises allowed by the casino (usually three raises) limits the aforementioned clockwise process. Once the maximum number of raises is reached at a given player, then the subsequent remaining players may only call the prior raises or may fold their hands. The total amount or value of the chips in the middle of table 20 after this 1st or pre-flop betting round is called the pot. The monetary value of the pot is dynamic because it increases each time a player calls, bets or raises. Those players remaining in the hand after the pre-flop betting round are still active players. In this example, the remaining active players after the pre-flop betting round are players 6, 7, 9, 1, 3 and 4 in clockwise order relative to button BU. Players 8, 10, 2 and 5 folded (dropped out of the hand) and are inactive players during the rest of the hand. See FIG. 2.

After the 1st or pre-flop betting round is complete, dealer D burns a card B1 face-down and places it on the table to his left or right. Dealer D next places three cards F1, F2 and F3 face-up on the center of the table in front of him. These three cards are called the flop cards. The remaining active players in the hand now commence the 2nd or post-flop betting round. During the post-flop betting round, player 6 may check by not betting or may bet $10. Player 7 may check if and only if player 6 checked, or may call $10 if player 6 bet $10, or may raise to $20 if player 6 bet $10, or may fold if player 6 bet $10. Player 9 may exercise one of the same options as player 7, and so on by players 1 and 3 until player 4 exercises one of his options. If player 4 still has an option to raise and in fact does raise, then players 6, 7, 9, 1 and 3 must meet the raise or must fold. Again, the maximum number of raises allowed by the casino limits the aforementioned clockwise process. Once the maximum number of raises is reached by a given remaining active player, then the subsequent remaining active players may only call or fold. The total amount or value of the chips in the middle of the table after this 2nd or post-flop betting round is the new pot amount. Those players remaining in the hand after the post-flop betting round are active players. In this example, the remaining active players after the post-flop betting round are players 6, 9, 1 and 3 in clockwise order relative to button BU. Players 7 and 4 folded (dropped out of the hand) and are now inactive players during the rest of the hand. See FIG. 3.

After the 2nd or post-flop betting round is complete, dealer D burns another card B2 face-down and places it on the table next to or on top burn card B1. Dealer D then deals another card TU face-up and places it on the table in line to the right of flop cards F1, F2 and F3. The remaining active players (6, 9, 1, and 3) now commence the 3rd or post-turn betting round. During the post-turn betting round, player 6 may check by betting no amount or may bet $20. Player 9 may check if and only if player 6 checked, or may call $20 if player 6 bet $20, or may raise to $40 if player 6 bet $20, or may fold his hand if player 6 bet $20. Player 1 may exercise the same options as player 9, and so on until player 3 exercises one of his options. If player 3 raises, then players 6, 9, and 1 must either meet the raise or must fold. Again, the maximum number of raises allowed by the casino limits this clockwise process. Once the maximum number of raises is reached at a given player, then the subsequent remaining players may only call or fold. The total amount or value of the chips in the middle of the table after this 3rd or post-turn betting round is the new pot amount. Those players remaining in the hand after the post-turn betting round are active players. In this example, the remaining active players after the post-turn betting round are players 6, 1 and 3 in clockwise order relative to button BU. Player 9 folded (dropped out of the hand) and is now an inactive player during the rest of the hand. See FIG. 4.

After the 3rd or post-turn betting round is complete, dealer D burns another card B3 face-down and places it on the table next to or top of burn cards B1 and B2. Dealer D then deals another card RI face-up and places it on the table in line with and to the right of cards F1, F2, F3 and TU. The remaining active players (6, 1, 3) in the hand now commence the 4th or post-river betting round. During the post-river betting round, player 6 may check by betting no amount or may bet $20. Player 1 may check if and only if player 6 checked, or may call $20 if player 6 bet $20, or may raise to $40 if player 6 bet $20, or may fold if player 6 bet $20. Player 3 may exercise one of the same options as player 1. If player 3 raises, then players 6 and 1 must either meet the raise or must fold their hands. Again, the maximum number of raises allowed by the casino limits the aforementioned clockwise process. Once the maximum number of raises is reached at a given remaining active player, then the subsequent remaining active players may only call or fold. The total amount or value of the chips in the middle of the table after this 4th or post-river betting round is the final pot amount. Those players remaining in the hand after the post-river betting round are active players. In this example, the remaining active players after the post-river betting round are players 6, 1 and 3 in clockwise order relative to button BU. See FIG. 5. After the 4th or post-river betting round is complete, each remaining active player (6, 1, 3) in clockwise order relative to button B must expose his two cards face-up. Then, upon exposing his two cards face-up, each player must declare to the dealer and to the other players the best poker hand that his two cards make in combination with the five face-up cards F1, F2, F3, TU and RI in the middle of the table. In most casinos, the dealer must read and declare out loud the best poker hand made by each player. In many cases, a player will not expose his two cards because such player concedes to himself that his best poker hand does not beat the other exposed poker hands. After all the players' cards are exposed and after all the best poker hands are declared, then the dealer declares the winner or winners of the main pot and of any side pots. If two or more players make the same best poker hand, then the main pot and/or any side pots are split between/among such winning players.

Poker hands are ranked as follows:

Royal straight flush such a 10 Jack Queen King Ace all of Spades or all Hearts or all Diamonds or all Clubs.

Straight flush such as Eight Nine Ten Jack Queen all of Spades or all Hearts or all Diamonds or all Clubs.

Four of a kind such as fours Aces or four Kings.

Full house such as three Aces plus two Kings.

Flush such as two five seven nine jack all of Spades or all Hearts or all Diamonds or all Clubs.

Straight such as four five six seven eight of different suits.

Three of a kind only such as ace ace ace.

Two pair such as ace ace plus two two.

One pair only such as ace ace.

High card only such as ace of Spades or Hearts or Diamonds or Clubs.

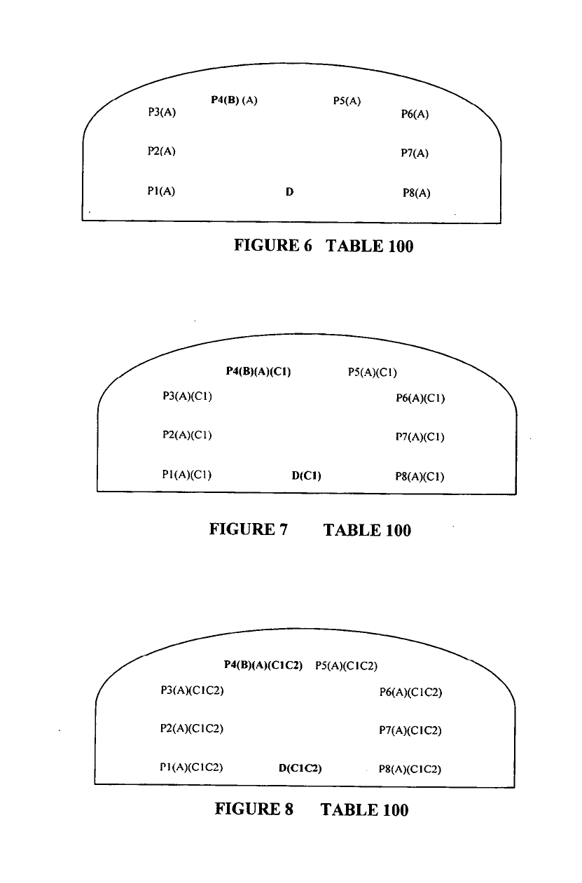

FIGS. 6 Through 8

FIGS. 6 through 8 are top views of poker table 100 showing how the two hole-cards are dealt face-down by dealer D in this limit Texas Holdem poker hand according to the present invention. More specifically, FIG. 6 is a top view of poker table 100 showing dealer D and players P1 through P8 in their respective positions at the table before the hand is played. FIG. 6 also shows that player P8 is designated the Button position B-before the hand is played. Finally, FIG. 6 also shows that each player P1 through P8 has placed his single ante bet amount A in front of him before the hand is played.

Further, FIG. 7 is a top view of poker table 100 showing dealer D and players P1 though P8 in their respective positions at the table each having been dealt by the dealer their respective first hole-card C1 face-down. In this example, player 5 is dealt first by the dealer because player 4 is designated the button B position. Thereafter, the clockwise dealing sequence effected by dealer D is players P6, P7, P8, dealer D, players P1, P2, P3 and P4.

Still further, FIG. 8 is a top view of poker table 100 showing dealer D and players P1 though P8 in their respective positions at the table each having been dealt by the dealer their respective first and second hole-cards C1 C2 face-down. Card C2 is dealt by dealer D in the same clockwise sequence stated above.

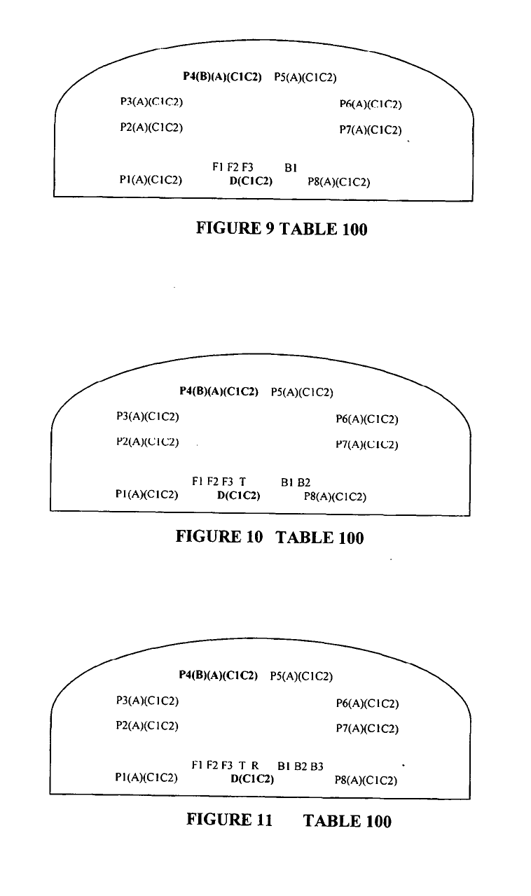

FIGS. 9 Through 11

FIGS. 9 through 11 are top views of poker table 100 showing how the five common or community cards are dealt face-up by dealer D in this limit Texas Holdem poker hand according to the present invention. More specifically, FIG. 9 shows the first burn card B1 face-down plus the three flop cards F1 F2 F3 face-up. Dealer D first deals burn card B1 face-down and then he deals the three flop cards F1 F2 F3 face-up.

Further, FIG. 10 shows the first burn card B1 face-down, the second burn card B2 face-down, the three flop cards F1 F2 F3 face-up, and the turn card T face-up. Dealer D first deals burn card B2 face-down and then he deals the turn card T face-up.

Still further, FIG. 10 shows the first burn card B1 face-down, the second burn card B2 face-down, the third burn card B3 face-down, the three flop cards F1 F2 F3 face-up, the turn card T face-up, and the river card R face-up. Dealer D first deals burn card B3 face-down and then he deals the river card R face-up.

At this point at the end of the dealing, each player and dealer D each turns over his respective two hole-cards C1 C2 face-up. Each player may now declare his best poker hand utilizing his two cards C1 C2 face-up plus the five common or community cards F1 F2 F3 T R. Dealer D then confirms the best poker hand of each player plus that of the dealer. The dealer then pays out the combined antes totaling 8A to the respective winning player, players and/or the dealer after deducting the casino or house rake amount and the bad-beat jackpot rake amount as hereinafter described.

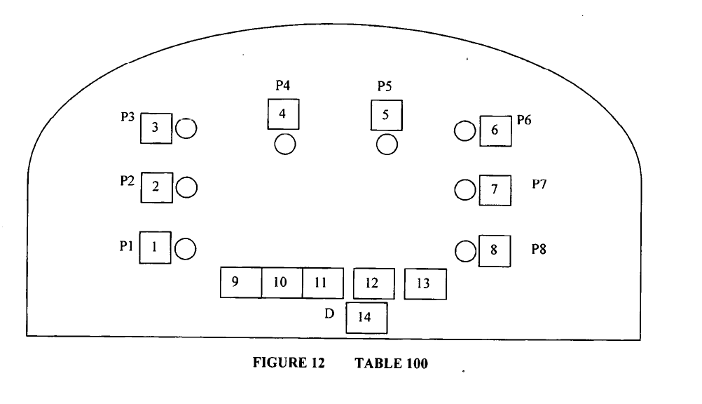

FIG. 12

FIG. 12 is a top view of poker table 100 showing the various designated regions of the table according to the present invention. FIG. 12 shows players P1 through P8 seated in front of their assigned positions on the table. For illustrative purposes only, in front of player P1 is his designated circular region or area in which player P1 places his ante bet before all cards C1C2 are dealt by dealer D to all the players and the dealer. For illustrative purposes only, also in front of player P1 is designated square region or area 1 in which player P1 places his two hole-cards face down after all cards C1C2 are dealt by dealer D to all the players and the dealer. The same explanation applies to all other players P2 to P8 with respect to their respectively assigned designated circular regions or areas and assigned square regions or areas. The same explanation applies to dealer D with respect to his assigned designated square region or area 14 in which he places his two hole-cards face down. For illustrative purposes only, FIG. 12 also shows designated square regions or areas 9-10-11 in front of dealer D wherein the dealer places the initial three-card flop face-up. Also shown is designated square region or area 12 wherein the dealer places the turn card face-up. Also shown is designated square region or area 13 wherein the dealer places the river card face-up.

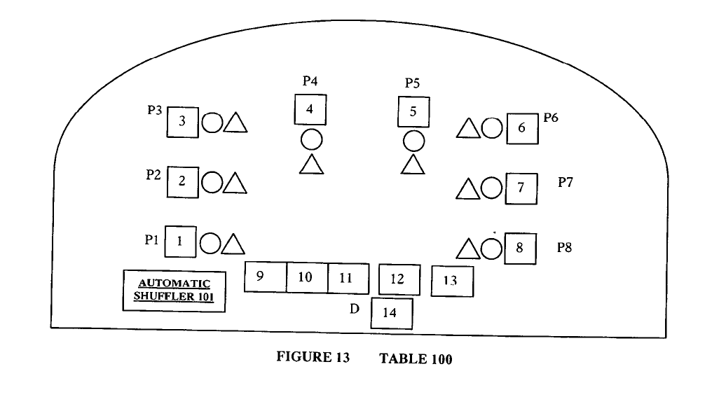

FIG. 13

FIG. 13 is a top view of poker table 100 showing the various designated regions of the table featuring optional bonus betting according to the present invention. FIG. 13 shows players P1 through P8 seated in front of their assigned positions on the table. For illustrative purposes only, in front of player P1 is his designated circular region or area in which player P1 places his ante bet before all cards C1C2 are dealt to all the players and the dealer. For illustrative purposes only, also in front of player P1 is designated square region or area 1 in which player P1 places his two cards face down after all cards C1C2 are dealt to all the players and the dealer. The same explanation applies to all other players P2 to P8 with respect to their respectively assigned designated circular regions or areas and assigned square regions or areas. The same explanation applies to the dealer with respect to his assigned designated square region or area 14 in which he places his two cards face down. For illustrative purposes only, FIG. 13 also shows designated square regions or areas 9-10-11 in front of the dealer wherein the dealer places the initial three-card flop face-up. Also shown is designated square region or area 12 wherein the dealer places the turn card face-up. Also shown is designated square region or area 13 wherein the dealer places the river card face-up. For illustrative purposes only, also shown in front of each player P1 to P8 is a triangular area for placing the optional bonus bet before all cards are dealt to all the players and the dealer. For illustrative purposes only, in FIG. 13 (and in FIGS. 6, 7, 8, 9, 10, 11, and 12) table 100 may be equipped with an automatic shuffling machine 101 for shuffling the 52-card deck after each hand and to prepare the deck for the next hand.

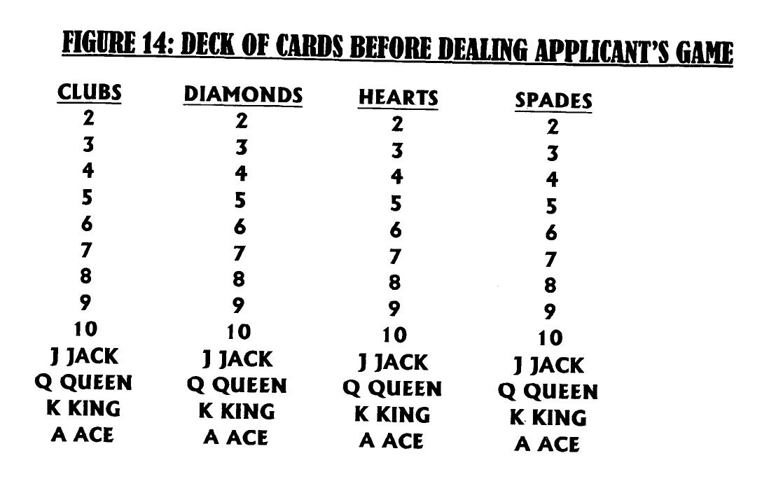

FIG. 14

FIG. 14 shows the standard deck of 52 cards before dealing applicant's game. The standard deck of cards comprises card suits: clubs, diamonds, hearts and spades. The standard deck of cards comprises the numbered cards: 2, 3, 4, 5, 6, 7, 8, 9, 10, jack, queen, king and ace. The standard deck of cards comprises thirteen numbered cards in each of four suits for a total of 52 cards.

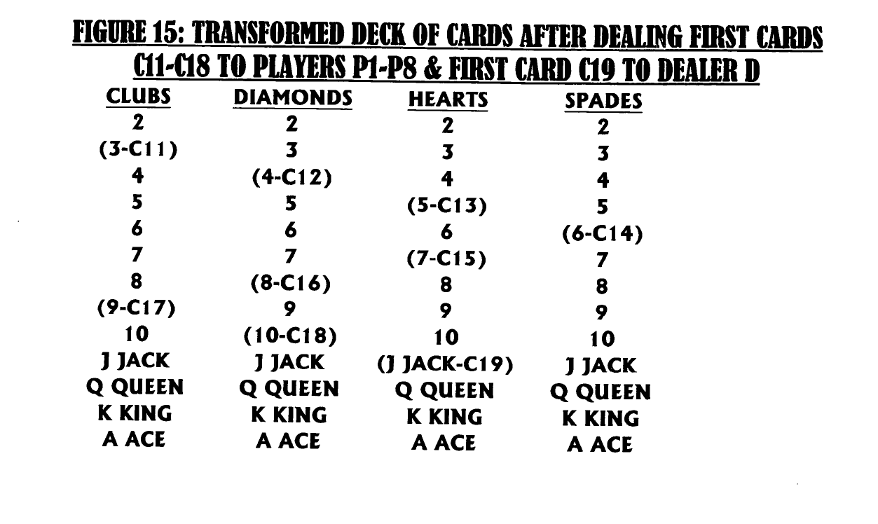

FIG. 15

FIG. 15 shows the transformed deck of cards after respectively dealing first cards C11-C18 to players P1-P8 and first card C19 to dealer D. For illustrative purposes only, the current explanation describes applicant's game being played by eight participating players plus the dealer. The current game can be played by seven, six, five, four, three, two or one participating player plus the dealer. In this first step or stage of applicant's game with eight participating players plus the dealer, the deck is depleted by or of 9 cards thereby leaving only 43 cards in the deck with the 9 cards being dealt or distributed to the players and the dealer all face-down. The card deck is transformed in this first step or stage of applicant's game as aformentioned.

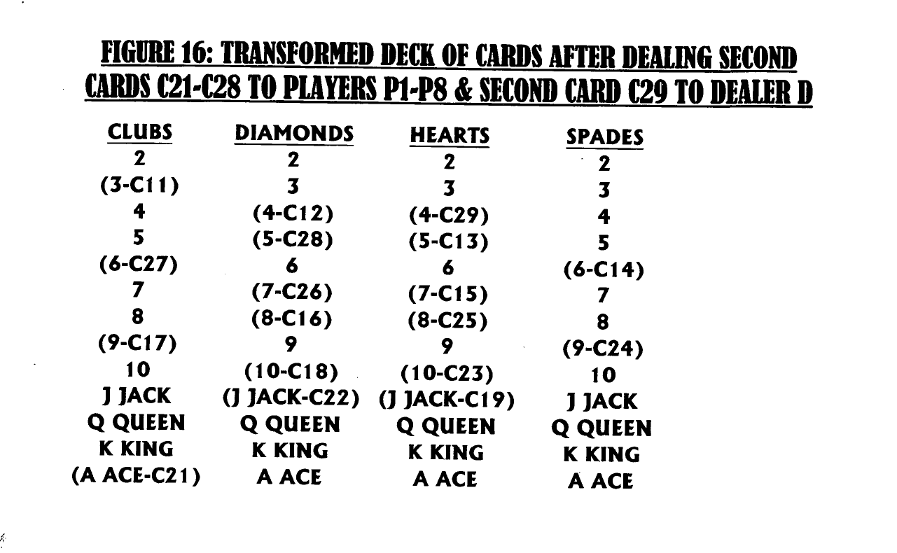

FIG. 16

FIG. 16 shows the transformed deck of cards after respectively dealing second cards C21-C28 to players P(1)-P(8) and second card C29 to dealer D. In this second step or stage of applicant's game with eight participating players plus the dealer, the deck is further depleted of 9 more cards thereby leaving only 34 cards in the deck with the further 9 cards being dealt or distributed to the players and the dealer all face-down. The card deck is further transformed in this second step or stage of applicant's game as aformentioned.

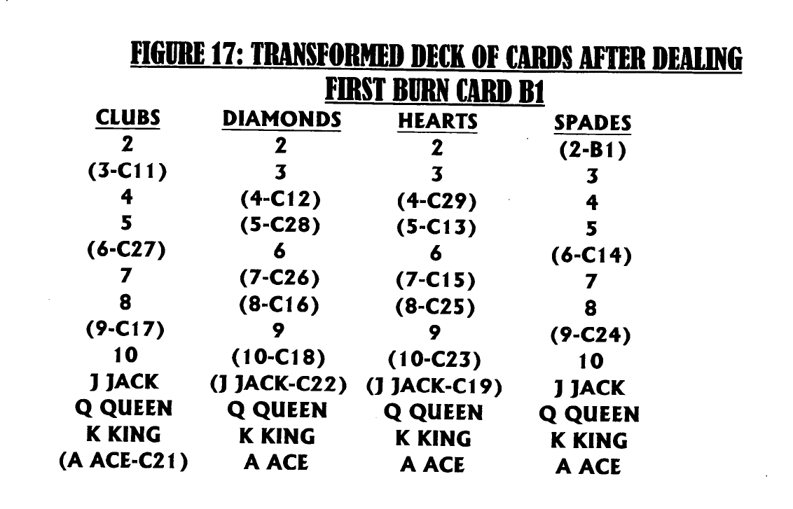

FIG. 17

FIG. 17 shows the transformed deck of cards after dealing first burn card B1. In this third step or stage of applicant's game with eight participating players plus the dealer, the deck is further depleted by or of one more card thereby leaving only 33 cards in the deck with the further one card being dealt or placed onto the card table face-down. The card deck is further transformed in this third step or stage of applicant's game as aformentioned.

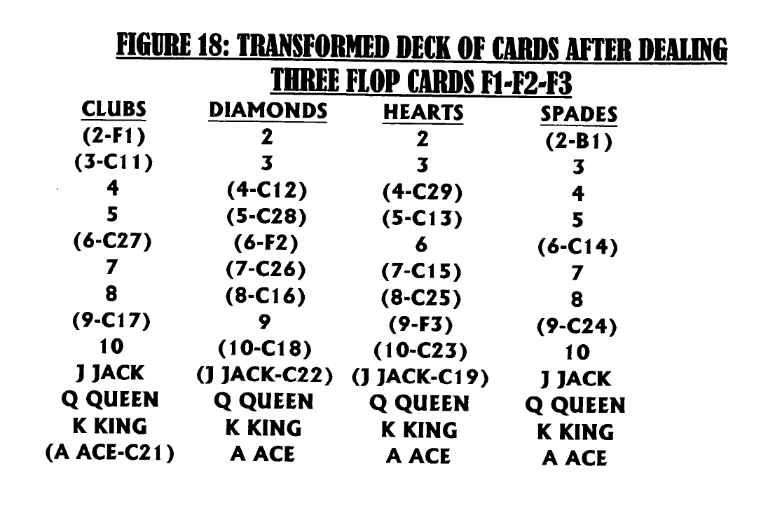

FIG. 18

FIG. 18 shows the transformed deck of cards after dealing 3 flop cards F1-F2-F3). In this fourth step or stage of applicant's game with eight participating players plus the dealer, the deck is further depleted of or by 3 more cards thereby leaving only 30 cards in the deck with the further 3 cards being dealt or placed onto the card table. The card deck is further transformed in this fourth step or stage of applicant's game as aformentioned.

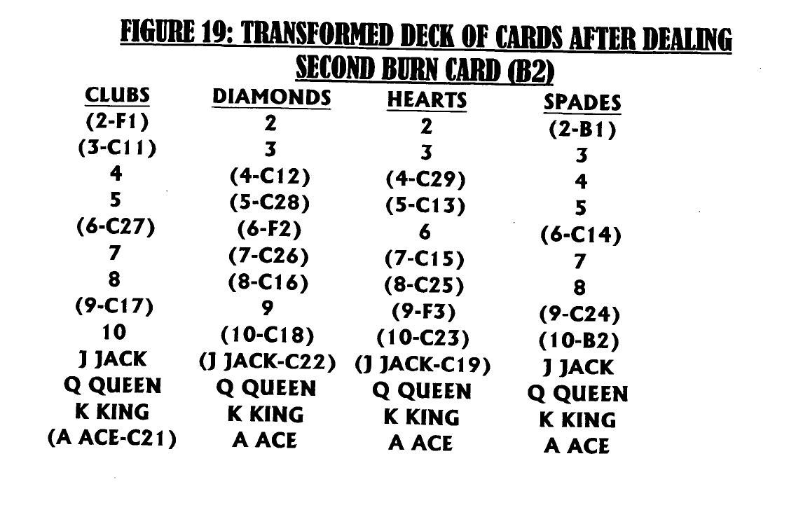

FIG. 19

FIG. 19 shows the transformed deck of cards after dealing second burn card B2. In this fifth step or stage of applicant's game with eight participating players plus the dealer, the deck is further depleted by or of one more card thereby leaving only 29 cards in the deck with the further one card being dealt or placed onto the card table next to first burn card B1. The card deck is further transformed in this fifth step or stage of applicant's game as aformentioned.

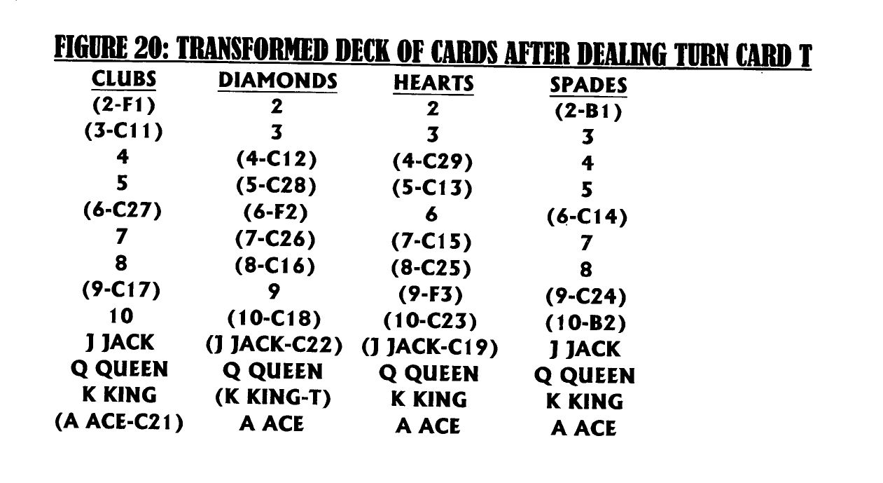

FIG. 20

FIG. 20 shows the transformed deck of cards after dealing turn card T. In this fifth step or stage of applicant's game with eight participating players plus the dealer, the deck is further depleted of one more card thereby leaving only 28 cards in the deck with the further one card being dealt or placed onto the card table next to flop cards F1-F2-F3 face up. The card deck is further transformed in this fifth step or stage of applicant's game as aformentioned.

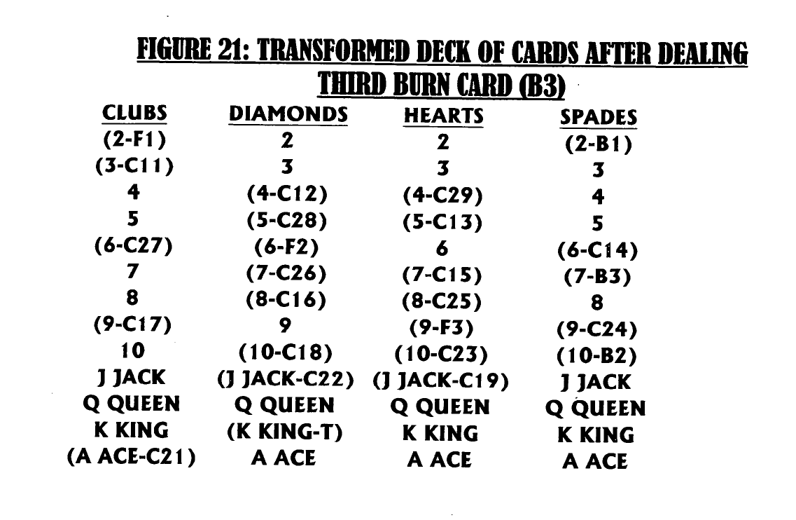

FIG. 21

FIG. 21 shows the transformed deck of cards after dealing third burn card B3. In this sixth step or stage of applicant's game with eight participating players plus the dealer, the deck is further depleted of one more card thereby leaving only 27 cards in the deck with the further one card being dealt or placed onto the card table next to first burn card B1 and second burn card B2 face-down. The card deck is further transformed in this sixth step or stage of applicant's game as aformentioned.

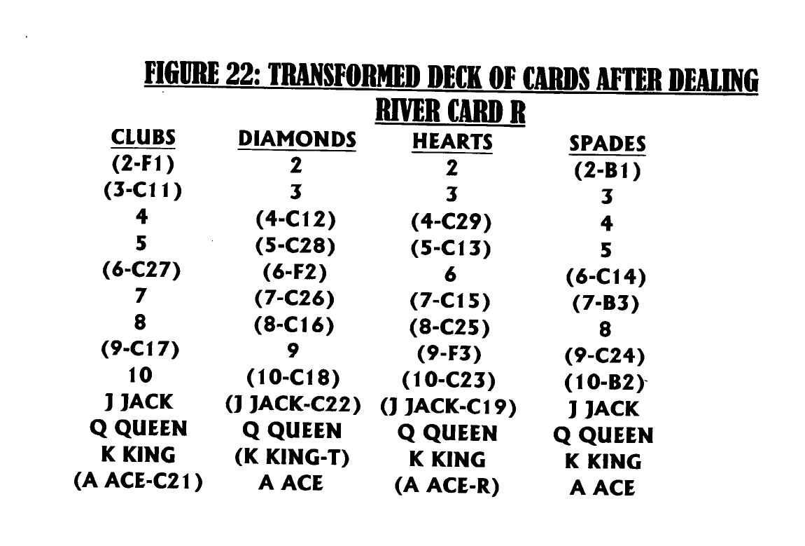

FIG. 22

FIG. 22 shows the transformed deck of cards after dealing river card R. In this seventh step or stage of applicant's game with eight participating players plus the dealer, the deck is further depleted by or of one more card thereby leaving only 26 cards in the deck with the further one card being dealt or placed onto the card table next to flop cards F1-F2-F3 and turn card T. The card deck is further transformed in this seventh step or stage of applicant's game as aformentioned.

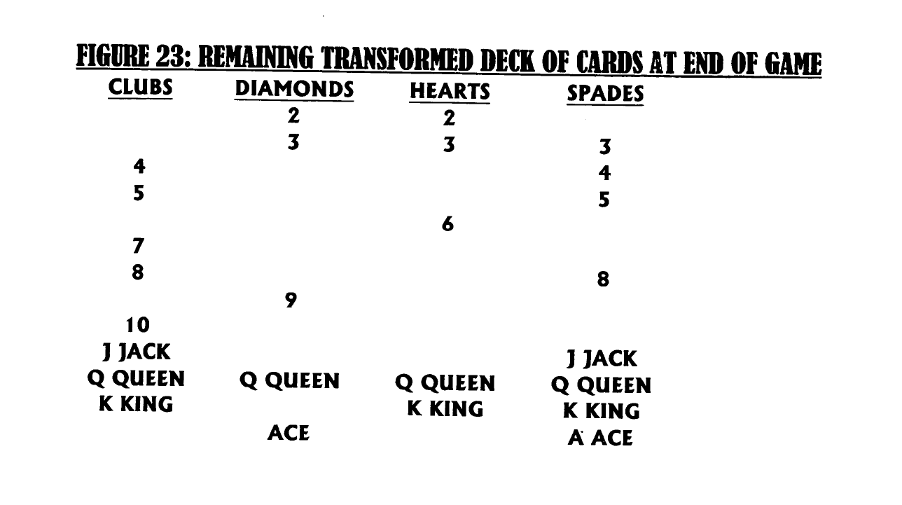

FIG. 23

FIG. 23 shows the final resulting or transformed deck of cards revealing only the remaining cards after dealing out river card R.

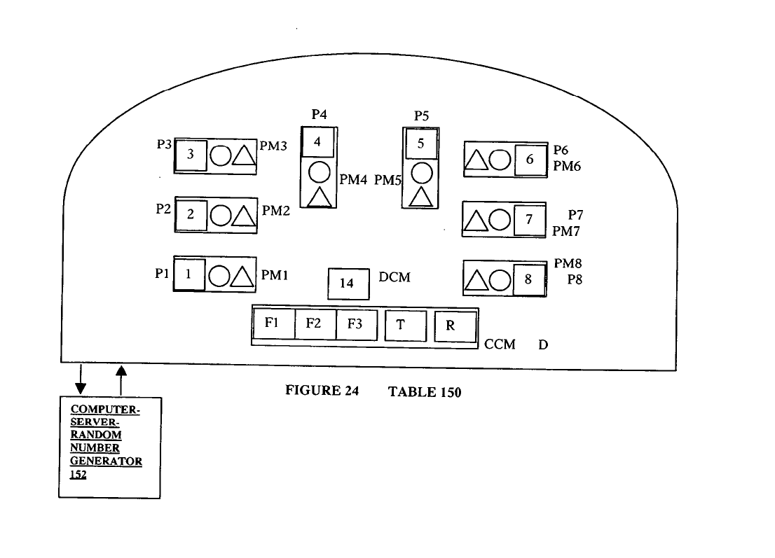

FIG. 24

FIG. 24 shows computerized real table 150 comprising: computer-server 152 including a random number generator and being connected to real table 150 for sending signals to each other and for receiving signals from each other; player touch-sensitive monitors PM1 to PM8; dealer touch-sensitive monitor DCM; and community-card touch-sensitive monitor CCM. The combination of computer-server 152 and the monitors are designated a computer system. Monitors PM1 to PM8 and DCM are responsive to computer-server 152 for displaying the generated cards face-down during the hand and then face-up at the end of the hand. Monitor CCM is responsive to computer-server 152 for displaying the generated cards face-up during the whole hand. Each player monitor PM displays: the circular area for placing the original single player amount or ante bet; the triangular area for placing the optional bet; and the square area for displaying the player's two cards face-down during the hand and face-up at the end of the hand after all five face-up community cards are displayed. The live dealer's two cards are displayed face-up on touch-sensitive monitor DCM at the end of the hand after all five face-up community cards are displayed on touch-sensitive monitor CCM. At the beginning of the hand the live dealer makes sure that all bets are properly and timely made by each player P1-P8 before the dealer activates computer-server 152 to generate and display the dealt cards on monitors PM1-PM8, DCM and CCM. The random number generator has stored therein the cards comprising the standard 52-card deck. Computer-server 152 automatically determines the winner who makes the best poker hand by rank as explained hereinbefore and hereinafter. The live dealer then pays or credits the net pot amount and/or the jackpot amount to the winning player(s). In the alternative, the live dealer pays or credits one-half of the original pot amount to himself and pays or credits each player with one-half of their original bet amount. Utilizing such a computerized table speeds up the game and allows for the playing of more games per hour.

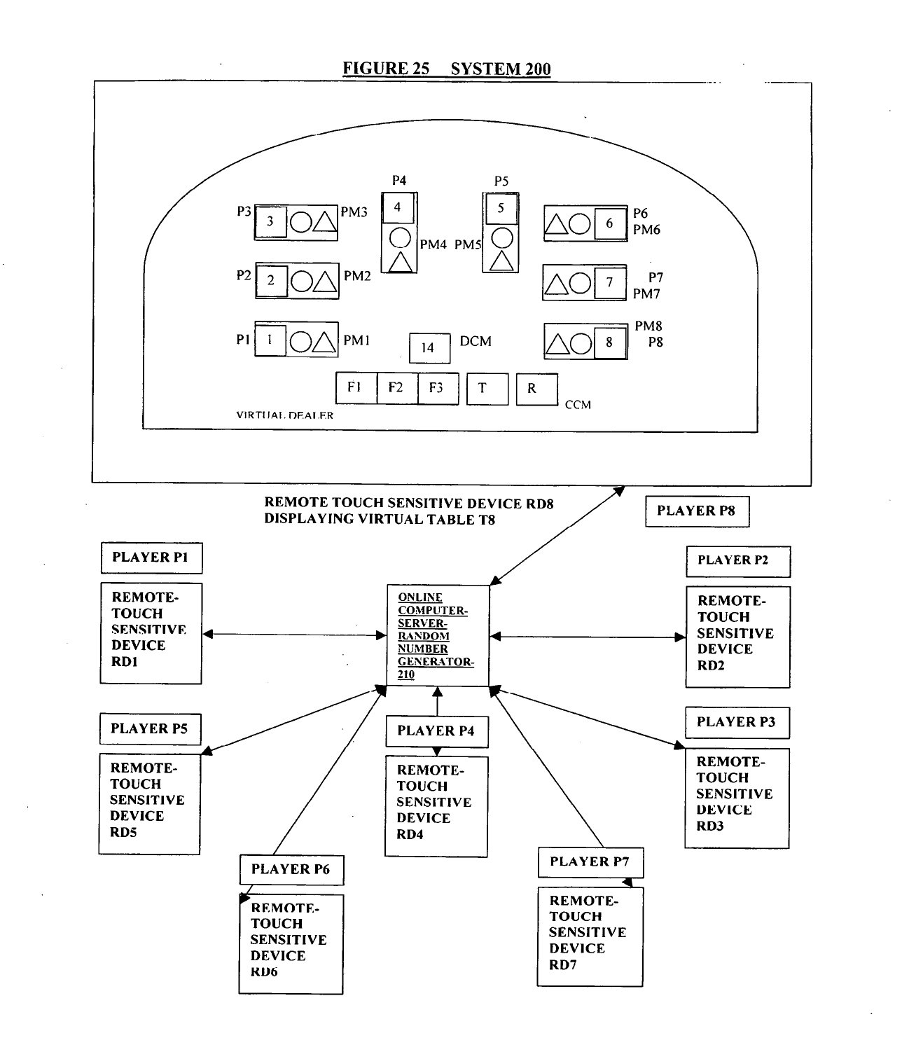

FIG. 25

FIG. 25 shows online network gaming system 200 comprising central server-computer 210 and a plurality RD1 to RDN of remote touch-sensitive devices such as tablets, I-pads, laptops, I-phones, personal computers or the like being respectively assigned to players P1 to PN. In this case virtual tables T1 to TN may be respectively displayed on the monitors of remote devices RD1 to RDN. Each virtual table may resemble real table 150 of FIG. 24. The embodiment of FIG. 24 may be expanded and modified to an online-version comprising centralized computer-server 210 and a virtual dealer and wherein each player P1 to PN may be respectively located at his own remote location RD1 to RDN with a touch-sensitive monitor device wherein each such device essentially displays real table 150 of FIG. 23 for game interaction. Each device RD1 to RDN is connected to central computer-server 210 via wired means or wireless means represented by the double-arrows.

No matter how many players are in the hand (from 2-8 players), the dealer's hand can play every time (and not just when there are 6-8 players in the hand) and the player is paid or credited a pre-defined percentage of his original bet or ante back ranging from 50% to 90% depending on: how many players are in the hand, the amount of the original bet or ante, and what percentage rake or hold the casino or house wants from the game.

This would be a viable option since a computer system could easily calculate and return an exact percentage to each player and not having to worry about breaking down physical casino chips into odd dollar and cents amounts which inevitably will occur when using any percentage giveback other than 50%.

The game can also be played entirely without the dealer's hand in play (from 2-8 players) with a flat percentage rake of the pot set by the casino or house, which again depends upon what percentage rake or hold the house wants from the game.

### Further Objects, Advantages and Features of the Present Invention

The poker game of the present invention may accommodate up to 10 players at the table. Limiting the game from 2 to 8 players instead of 10 players may make the bad-beat jackpot harder to hit per table, thereby allowing the bad-beat jackpot prize pool to get higher before it is hit. When the bad-beat jackpot pool gets to be over $100,000, it may draw more players to the tables. Limiting the game from 2 to 8 players instead of 10 players may also make the $1,000,000 super bad-beat jackpot harder to hit per table, thereby making it less expensive to insure.

Limiting the game to 8 players may also mean that more hands may be dealt per hour per table and more tables may be opened up and filled up more quickly.

Limiting the game to 8 players instead of 10 players may also allow the casino to use a smaller “clamshell” type table to save room on the casino floor. The tables may look like a poker room table and may be lower to the ground so that players may sit on chairs with their feet on the ground. This may allow onlookers to comfortably watch the game in progress. The casino may utilize a green cotton/polyester blend fabric AKA casino speedcloth on the top of the table.

Bridge-size plastic playing cards may be used as in regular poker room games.

When there are 2 to 5 players in the game, each hand may be raked at 5% of the pot up to a $6 maximum rake. If the pot is not in a multiple of $20 then the rake may be rounded up to the next dollar. For example, if the pot is $25, then the rake may be $2. There may also be a $1 drop for the bad-beat jackpot no matter what the size of the pot is.

When there are 6 to 8 players in the game then there may be NO rake per hand. The house may make money as is explained below. These rake rates apply to land based casinos. On cruise ship casinos, the cruise line operator may adjust the rake rates to manipulate the house edge percentages any way it desires.

There is no big blind and no small blind posted by the players. Players only ante EXACTLY the table ante and place it in the ante circle in front of their seat. The ante may be any of the following: $5, $10, $15, $20, $25 or any amount in increments of $5. If the ante requires more than one chip then each player is required to place his chips in the circle flat and next to each other so that the dealer may easily determine that each player has anted the correct amount (as opposed to stacking the chips on top of each another in which case each ante would have to be counted down every single hand by the dealer thereby slowing down the game). There may be no minimum buy-in for a player to sit down and play.

The dealer may then deal 2 cards face-down to each player (starting with the player to the left of the player with the dealer button) along with himself (the dealer/the house). There is no betting other than the ante. If any card is exposed during the course of dealing out the cards to any player or to the dealer (the house), then the exposed card IS NOT replaced, nor will the hand be declared a mis-deal. Since there are no actual betting decisions to be made, an exposed card is irrelevant.

After the deal, the players look at their starting two cards (if they choose to) and then may place their two cards face-down in the square in front of them next to their ante circle. The dealer then burns a card and deals out a 3-card flop of community cards in the center of the table marked off by a rectangle to place the cards in. The dealer then burns another card and turns a 4^{th} card, placing it in the appropriate box for the 4^{th} card. The dealer then burns another card and deals a 5^{th} card, placing it in the appropriate box for the 5^{th} card. There is NO BETTING during the course of the hand. There may be a 5-second or so delay in between the flop and the 4^{th} card and another 5-second or so delay in between the 4^{th} and 5^{th} cards to create excitement as the players determine what hand they have made and what cards they need to make their best poker hand.

If there are 2 to 5 players in the hand, then the dealer's (house's) hand does not play and the dealer then mucks his cards. The dealer then says “Showdown” and instructs the players to turn their two cards over and place them face-up back into their card square in front of them. The players' cards “speak for themselves” no matter what the player claims to have. The dealer then determines who happens to have the best poker hand and awards the pot to the player with the best poker hand (minus the house rake as determined above and minus $1 for the bad-beat jackpot as explained below).

If there are 6 to 8 players in the hand, then the dealer exposes his two hole-cards, then says “Showdown”, and then instructs the players to turn over their two cards and place them back face-up into their card square in front of them. The cards “speak for themselves” no matter what the player claims to have. The dealer then determines who happens to have the best poker hand and awards the pot to the player with the best poker hand (minus the $1 for the bad-beat jackpot as explained below). If the dealer (the house) has the best poker hand, then each player gets one-half of their ante back and the house drops $1 for the bad-beat jackpot and the remainder goes to the house. Players are allowed to throw their cards face-down into the “muck” if they so desire, but if they do so, then their hand is declared dead and they relinquish any rights to the pot. After the hand is over, the dealer moves the “dealer” button one player to the left and repeats the process over again. The dealer button will never be in front of the dealer (house). The dealer button will always move by the dealer to the first player to his left.

If two or more players end up with the same best poker hand, then the pot will be split equally (minus the house rake and minus the bad-beat jackpot drop) between or among the players with the same best poker hand. If there are any odd chips left over, then the first extra chip is awarded to the player holding a Spade in his winning best poker hand. The next extra chip (if any) is then awarded to the player with a Heart in his winning best poker hand; then to the Diamond; and lastly to the Club. If the board plays (in which case no player has a best poker hand better than the board poker hand), then the extra chips are awarded to the player with the highest Spade in their two hole-cards. If no one has a spade then to the highest Heart, then to the highest Diamond, and then to the highest Club.

If the dealer is involved in a split pot, then the dealer takes out the $1 bad-beat jackpot drop, and then divides the remaining money evenly among or between the house and the player(s) who tie for the best poker hand. In this case, there will be no one-half refunding of the losing players' antes. Also, if there is an extra odd chip, then the other player or players with the best poker hand always gets the extra chip. The dealer (the house) is never eligible to receive the extra chip.

The Bad-beat jackpot rake is $1 per hand from the pot. (Not from each player). The casino seeds the bad-beat jackpot with $5,000 to get it started. This amount will be recouped as the bad-beat jackpot drops accumulate. A bad-beat occurs when a player loses holding a minimum hand of 4 of a kind or a straight flush (while holding a pocket pair or 2 suited cards that both play in the straight flush) and losing to a higher 4 of a kind (with the other player holding a pocket pair as well) or losing to a straight flush (with the other player's 2 hole-cards both playing in the straight flush). Payouts for the bad-beat jackpot may be as follows: The player with the qualifying hand that loses the hand may get up to 50% of the total bad-beat jackpot prize pool. The player with the qualifying hand that wins the hand may get up to 25% of the total bad-beat jackpot prize pool. The remaining players in the hand then divide up the remainder of the bad-beat jackpot prize pool.

If the dealer (the house) has one of the 2 bad-beat jackpot qualifying hands then the bad-beat jackpot is null and void and is not awarded to any player. The house also does not get a table share of the bad-beat jackpot if the dealer does not have one of the 2 bad-beat jackpot qualifying hands. In other words, the dealer (the house) cannot trigger nor partake in any portion of the bad-beat jackpot prize pool or in the $1,000,000 Super Bad-beat Jackpot prize pool as described below. Each player at the table that did not have either the winning poker hand or the losing poker hand in the bad-beat jackpot is eligible to receive a portion of the bad-beat jackpot prize pool pot as long as they played the hand and did not miss the button in their circle in front of them.

When a player sits out of any hand from any position on the table, then such player gets a large “missed hand button” that is the same size as the ante circle and is placed in their ante circle to indicate that they did not play the hand.

70% of each $1 dropped for the bad-beat jackpot may go towards the current bad-beat jackpot; 20% of each $1 dropped may be carried forward to seed the next bad-beat jackpot after the current one is hit; and 10% may go towards insuring the $1,000,000 Super Bad-beat Jackpot (through Lloyds of London or another insurer carrier); and whatever is left over may go to the casino (the house) for “administrative” fees. This % breakdown may be subject to revision by the casino.

A $1,000,000 Super Bad-beat Jackpot may be awarded if anyone loses with 4 aces while holding 2 aces as a pocket pair to a Royal Flush in the suit of SPADES with the other player holding 2 cards that comprise the spades royal flush. The payout may be as follows: The player with the spade royal flush may win up to $500,000. The player with the 4 aces may win up to $250,000. The remaining players at the table may equally divide up the remainder. All payouts may be paid out over 20 years in the form of an annuity. The requirements to be eligible for a “table sitter” share are the same as they are for the regular bad-beat jackpot. If the dealer (the house) has one of the 2 qualifying hands, then the $1,000,000 Super Bad-beat Jackpot is null and void. The house also does not get a table share of the super bad-beat jackpot if the house does not have either one of the 2 bad-beat qualifying hands.

The odds of the $1,000,000 Super Bad-beat Jackpot being hit are as follows:
8-handed: about 62,768,380 to 1
7-handed: about 83,678,528 to 1
6-handed: about 117,132,240 to 1
5-handed: about 175,671,816 to 1
4-handed: about 292,742,136 to 1
3-handed: about 585,395,848 to 1
2-handed: about 1,755,922,348 to 1

Use of an automatic card shuffler. A three-deck shuffling unit may be ideal when the game is short handed so that the hands may play quickly. While a player may not want the pace of play to get too fast, a player may also not want the pace of play to come to a halt while waiting for the cards to shuffle. About one hand per minute (perhaps one hand per 45 seconds when short handed) may be ideal. This would allow for a comfortable pace of play. The dealer may hand-shuffle when there are fewer than 5 players since the shuffle machine may take about 50 seconds and would slow down the pace of play too much.

The $1 drop for the bad-beat jackpot may allow the house to know EXACTLY how many hands have been dealt because $1 is dropped for the bad-beat jackpot every single hand no matter how many players are in the hand.

The way that the rake is designed means that almost every pot ends up with some $1 chips in it. This is ideal for creating chips for tipping the dealer, thereby keeping the dealers happy and not slowing the game down too often to make change after the pot is awarded.

The floor-person in charge may try to maintain the tables with an even-number of players so that the table with the fewest players may get the next new player if more than one table is running. But any player may sit at any table they so desire. Also, the floor person may allow players who want to play together to sit at the same table if they so desire, even if the tables have an even number of players. People may be much more likely to play if they can sit and play with their friends or spouse.

Comps for players may be $1 per hour for every $10 of ante.

An alternative $1,000,000/$5,000,000 Super Bad-beat Jackpot payout may be as follows: Quad 2's losing to a Royal Flush for a $1,000,000 payout the same way as above. The odds of this happening may be about 128,767,639-to-1 in a 10-handed game. The odds may about 200,000,000 to 1 in an 8-handed game. Quad 2's losing to a Royal Flush in Spades may qualify for a $5,000,000 pay out the same way as above. The odds of this happening are about 515,070,556 to 1 in a 10-handed game. The odds in an 8-handed game are about 800,000,000 to 1.

Free Bonus Payouts: There is no extra side bet required, nor is there any extra rake taken out of the pot for these free bonus payouts when a player makes a straight, a flush, a full-house, four of a kind, a straight flush, or a royal flush.

Bonus Payout Schedule A. This is suggested if there is not going to be a $1 side-bet bonus payout schedule.
$100 bonus for making 4 of a kind (flopping quads) after only the first 3 community cards are exposed while holding a pocket pair.
$500 bonus for making 4 aces (flopping quads aces) after only the first 3 community cards are exposed while holding a pocket pair of aces.
$125 bonus for making any straight flush. (with either one or both hole-cards playing).
$500 bonus for making a straight flush (flopping it) after only the first 3 community cards are exposed, while holding both hole-cards that help make up the straight flush.
$1,000 bonus for making any royal flush (with either one or both hole-cards playing).
$2,500 bonus for making a royal flush (flopping it) after only the first 3 community cards are exposed while holding both hole-cards that help make up the royal flush.

Bonus Payout Schedule B. This Free Bonus Payout Schedule is designed to be used in conjunction with a $1 side bet Bonus Multiplier. See below for the $1 side bet bonus payout schedule B1.
$25 bonus for making 4 of a kind (flopping quads) after only the first 3 community cards are exposed while holding a pocket pair.
$150 bonus for making 4 aces (flopping quads aces) after only the first 3 community cards are exposed while holding a pocket pair of aces.
$25 bonus for making any straight flush. (with either one or both hole-cards playing).
$150 bonus for making a straight flush (flopping it) after only the first 3 community cards are exposed, while holding both hole-cards that help make up the straight flush.
$200 bonus for making any royal flush (with either one or both hole-cards playing).
$2,500 bonus for making a royal flush (flopping it) after only the first 3 community cards are exposed while holding both hole-cards that help make up the royal flush.

This is the $1 side bet Bonus Payout Schedule B1:
$5 for making any flush.
$10 for making any full house.
$50 bonus for making any 4 of a kind.
$250 bonus for making 4 of a kind (flopping quads) after only the first 3 community cards are exposed while holding a pocket pair.
$1,500 bonus for making 4 aces (flopping quads aces) after only the first 3 community cards are exposed while holding a pocket pair of aces.
$250 bonus for making any straight flush (with either one or both hole-cards playing).
$1,500 bonus for making a straight flush (flopping it) after only the first 3 community cards are exposed, while holding both hole-cards that help make up the straight flush.
$2,000 bonus for making any royal flush (with either one or both hole-cards playing).
$25,000 bonus for making a royal flush (flopping it) after only the first 3 community cards are exposed while holding both hole-cards that help make up the royal flush.

Total Payouts Per 649,730 Hands Dealt: about 39,064 (or about 16.63 to 1); Total Money paid out: about $509,879; House Edge: about 21.52%. The house edge may be slightly smaller if the bonus is to be paid out on straight flushes and royal flushes when they make up the board.

Advantages: It will pay out many more times thereby giving the players some kind of a payback about once every 16 hands or so. The House edge is about 21.52% which will almost eliminate the possibility of the house ever losing money over a large sampling of hands even in the event of an abnormal standard deviation. The House pays out a very small % of profits in the form of “Free Bonuses”, thereby making the house edge higher on the regular playing of the game.

This is Bonus Payout Schedule C. This Free Bonus Payout Schedule is designed to be used in conjunction with a $1 side bet Bonus Multiplier. See below for the $1 side bet bonus payout schedule C1, C2 & C3.
$100 bonus for making 4 of a kind (flopping quads) after only the first 3 community cards are exposed while holding a pocket pair.
$500 bonus for making 4 aces (flopping quads aces) after only the first 3 community cards are exposed while holding a pocket pair of aces.
$50 bonus for making any straight flush. (with either one or both hole-cards playing).
$500 bonus for making a straight flush (flopping it) after only the first 3 community cards are exposed, while holding both hole-cards that help make up the straight flush.
$1,000 bonus for making any royal flush (with either one or both hole-cards playing).
$2,500 bonus for making a royal flush (flopping it) after only the first 3 community cards are exposed while holding both hole-cards that help make up the royal flush.

This is the $1 side bet Bonus Payout Schedule C1. It uses a 5× multiplier except that is uses a 10× multiplier for flopping a Royal Flush and it also pays out for any 4 of a kind and any full house. It does not pay out for making any flushes.
$10 for making any full house.
$50 bonus for making any 4 of a kind.
$500 bonus for making 4 of a kind (flopping quads) after only the first 3 community cards are exposed while holding a pocket pair.
$2,500 bonus for making 4 aces (flopping quads aces) after only the first 3 community cards are exposed while holding a pocket pair of aces.
$250 bonus for making any straight flush. (with either one or both hole-cards playing).
$2,500 bonus for making a straight flush (flopping it) after only the first 3 community cards are exposed, while holding both hole-cards that help make up the straight flush.
$5,000 bonus for making any royal flush (with either one or both hole-cards playing).
$25,000 bonus for making a royal flush (flopping it) after only the first 3 community cards are exposed while holding both hole-cards that help make up the royal flush.

Total Payouts Per 649,730 Hands Dealt: about 18,823 (or about 34.52 to 1); Total Money paid out: about $508,307; House Edge: about 21.77%.

Advantages: It will pay out many more times to give the players some kind of a payback about once every 35 hands or so. The House Edge is about 21.77% which will almost eliminate the possibility of the house ever losing money on this over a large sampling of hands even in the event of an abnormal standard deviation.

This is the $1 side bet Bonus Payout Schedule C2. It uses a straight 10× multiplier of the Free Bonus Payout Schedule C. It does not pay out for making any flushes, full houses or 4 of a kinds that are not flopped.
$1,000 bonus for making 4 of a kind (flopping quads) after only the first 3 community cards are exposed while holding a pocket pair.
$5,000 bonus for making 4 aces (flopping quads aces) after only the first 3 community cards are exposed while holding a pocket pair of aces.
$500 bonus for making any straight flush. (with either one or both hole-cards playing).
$5,000 bonus for making a straight flush (flopping it) after only the first 3 community cards are exposed, while holding both hole-cards that help make up the straight flush.
$10,000 bonus for making any royal flush (with either one or both hole-cards playing).
$25,000 bonus for making a royal flush (flopping it) after only the first 3 community cards are exposed while holding both hole-cards that help make up the royal flush.

Total Payouts Per 649,730 Hands Dealt: about 403 (or about 1,613 to 1); Total Money paid out: about $535,710; House Edge: about 17.55%.

Advantages: The winners of any bonus would be very obvious so it would not slow the game down. The bonus payouts for these hands are twice as big as the 5× multiplier.

This is the $1 side bet Bonus Payout Schedule C3. This is a straight 5× multiplier of Bonus Payout Schedule C. It also includes payouts for any 4 of a kind, any full house and any flush.
$5 for making any flush.
$10 for making any full house.
$50 bonus for making any 4 of a kind.
$500 bonus for making 4 of a kind (flopping quads) after only the first 3 community cards are exposed while holding a pocket pair.
$2,500 bonus for making 4 aces (flopping quads aces) after only the first 3 community cards are exposed while holding a pocket pair of aces.
$250 bonus for making any straight flush. (with either one or both hole-cards playing).
$2,500 bonus for making a straight flush (flopping it) after only the first 3 community cards are exposed, while holding both hole-cards that help make up the straight flush.
$5,000 bonus for making any royal flush (with either one or both hole-cards playing).
$12,500 bonus for making a royal flush (flopping it) after only the first 3 community cards are exposed while holding both hole-cards that help make up the royal flush.

Total Payouts Per 649,730 Hands Dealt: about 39,064 (or about 16.63 to 1); Total Money paid out: about $597,011; House Edge: about 8.11%.

Advantages: It will pay out many more times to give the players some kind of a payback about once every 16 hands or so.

The alternative $1,000,000 Super Bad-beat Jackpot would be awarded to anyone who loses to a Royal Flush when holding four deuces. So, the board must have a pair of deuces and three cards to a royal flush such as Ah-2c-Jh-2s-10h

There are about 240 boards similar to that above shown which may allow both quad deuces and a royal flush, out of about 2,598,960 possible, a probability of about 0.000092, or about 10,828-to-1 against. [p=C(4,2)*C(5,3)*4/C(52,5)]

The players' twenty cards must have among them the other two deuces and the two royal flush cards, 2d-2h-Kh-Qh, a probability of about 0.02716, or 36-to-1 against. [p=C(43,16)/C(47,20)]

Two of the ten players must hold those four cards in their hands, a probability of about 0.000619, or about 107-to-1 against. [p=3!!*15!!/19!!]

Those four key cards could be dealt Kh-2h and Qh-2d, Kh-2d and Qh-2h, or Kh-Qh and 2h-2d. Only one combination wins the jackpot, so that event has a probability of ⅓.

Multiply those probabilities and the hand odds are about 128,767,639-to-1 against anyone at the table losing to a Royal Flush while holding quad deuces. For any one person in particular, in a ten-handed game, the odds are ten times larger, more than a billion-to-1 against.

Omaha Poker

The principles of the present invention may be applied to the poker game called “Omaha poker” wherein each player P1 to PN and the dealer are each dealt four hole-cards C1 C2 C3 C4 face-down. In such case, each player and the dealer may use only two of his respective four hole-cards C1 C2 C3 C4 to make the best poker hand in combination with three of the five face-up community cards F1 F2 F3 T R. The best player hand and/or the best dealer hand may be paid or credited as stated above.

Pineapple Poker

The principles of the present invention may be applied to the poker game called “Pineapple poker” wherein each player P1 to PN and the dealer are each dealt three hole-cards C1 C2 C3 face-down. In such case, each player P1 to PN and the dealer may use only two of his three hole-cards C1 C2 C3 to make the best poker hand in combination with the five face-up community cards F1 F2 F3 T R. The best player hand and/or the best dealer hand may be paid or credited as stated above.

While the present invention has been described in terms of specific illustrative embodiments, it will be apparent to those skilled in the art that many other embodiments and modifications are possible within the spirit and scope of the disclosed principle.

What is claimed is:

1. A method for playing a poker game with a 52-card deck comprising cards numbered 2, 3, 4, 5, 6, 7, 8, 9, 10, jack, queen, king and ace in the suits of clubs, diamonds, hearts and spades; said method involving a dealer and a plurality N of players P1 to PN; said method comprising the steps of:
Each player P1 to PN wagering the same bet amount to create a pot;
Dealing in order a first card face-down to each player P1 to PN and to the dealer thereby resulting in a transformed deck with 52-(N+1) cards;
Dealing in order a second card face-down to each player P1 to PN and to the dealer thereby resulting in a transformed deck with 52-(N+1)-(N+1) cards;
Dealing a first burn card face-down thereby resulting in a transformed deck with 52-(N+1)-(N+1)-1 cards;
Dealing three community cards face-up thereby resulting in a transformed deck with 52-(N+1)-(N+1)-1-3 cards;
Dealing a second burn card face-down thereby resulting in a transformed deck with 52-(N+1)-(N+1)-1-3-1 cards;
Dealing a fourth community card face-up thereby resulting in a transformed deck with 52-(N+1)-(N+1)-1-3-1-1 cards;
Dealing a third burn card face-down thereby resulting in a transformed deck with 52-(N+1)-(N+1)-1-3-1-1-1 cards;
Dealing a fifth community card face-up thereby resulting in a transformed deck with 52-(N+1)-(N+1)-1-3-1-1-1-1 cards;
Exposing face-up the two cards of each player P1 to PN and the dealer; and
Determining the best poker hand for each player's two cards and the best poker hand for the dealer's two cards in combination with the five face-up community cards.

2. In the method of claim 1, paying or crediting the net pot amount to the player who makes the best poker hand higher than the dealer's best poker hand.

3. In the method of claim 1, paying or crediting one-half of the net pot amount to the dealer who makes the best poker hand higher than all the players' best poker hands; and returning to each player one-half of each player's original bet amount.

4. In the method of claim 1, paying or crediting one-half of the net pot amount to the player who makes the best poker hand; and paying or crediting one-half of the net pot amount to the dealer who also makes such best poker hand.

5. In the method of claim 1, paying or crediting an equal share of the net pot amount to the players who each make the same best poker hand higher than the dealer's best poker hand.

6. In the method of claim 1, paying or crediting up to one-half of the bad-beat jackpot pool amount to the player who makes a poker hand of four-of-a-kind or a straight flush using his two cards in combination with the five face-up community cards;
Paying or crediting a minority of the bad-beat jackpot pool amount to the player who makes a better poker hand of four-of-a-kind, a straight flush or a royal straight flush using his two cards in combination with the five face-up community cards;
Paying or crediting to the other players each an equal portion of the remainder of the bad-beat jackpot pool amount; and
Not paying or crediting to the dealer any portion of the bad-beat jackpot pool amount.

7. In the method of claim 1, paying or crediting to each player and to the dealer, each an equal share of the divided net pot amount, should the five face-up community cards display a poker hand that is better than any players' best poker hand and better than the dealer's best poker hand.

8. In the method of claim 1, not paying or crediting any bad-beat jackpot amount to the player who makes a poker hand of four-of-a-kind or a straight flush using his two cards in combination with the five community cards face-up;
Not paying or crediting any bad-beat jackpot amount to the dealer should the dealer make a higher poker hand of four-of-kind, a straight flush or a royal straight flush using the dealer's two cards in combination with the five face-up community cards; and
Not paying or crediting any bad-beat jackpot amount to the other players in the hand.

9. In the method of claim 1, not paying or crediting any bad-beat jackpot amount to the dealer should the dealer make a poker hand of four-of-a-kind or a straight flush using the dealer's two cards in combination with the five face-up community cards;
Not paying or crediting any bad-beat jackpot amount to the player who makes a higher poker hand of four-of-a-kind, a straight flush or a royal straight flush using his two cards in combination with the five face-up community cards; and
Not paying or crediting any bad-beat jackpot amount to the other players in the hand.

10. In the method of claim 1, paying or crediting a minority of the super bad-beat jackpot pool amount to the player who makes a poker hand of four aces using his two ace cards in combination with the five face-up community cards;
Paying or crediting up to a majority of the super bad-beat jackpot pool amount to the player who makes a poker hand of a royal straight flush in spades using his two cards in combination with the five face-up community cards;
Paying or crediting an equal portion of the remainder of the super bad-beat jackpot pool amount to the other players in the hand; and
Not paying or crediting to the dealer any portion of the super bad-beat jackpot pool amount.

11. In the method of claim 1, the dealer surrendering his two cards and not participating in any money distribution whenever there are two to five players in the hand.

12. In the method of claim 1, the dealer playing his two cards and participating in the money distribution depending on his best poker hand whenever there are six or more players in the hand.

13. In the method of claim 1, the dealer being a live dealer who utilizes manual hand shuffling whenever there are two to five players in the hand.

14. In the method of claim 1, the dealer being a live dealer who utilizes an automatic shuffling machine.

15. In the method of claim 10, utilizing an insurance carrier to insure the super bad-beat jackpot amount.

16. In the method of claim 1, paying or crediting a minority of the super bad-beat jackpot pool amount to the player who makes a poker hand of four deuces using his two deuces in combination with the five face-up community cards;
Paying or crediting up to a majority of the super bad-beat jackpot pool amount to the player who makes a poker hand of a royal straight flush in spades using his two cards in combination with the five face-up community cards;
Paying or crediting an equal portion of the remainder of the super bad-beat jackpot pool amount to the other players in the hand; and
Not paying or crediting any portion of the super bad-beat jackpot pool amount to the dealer.

17. In the method of claim 1, paying or crediting a pre-determined bonus amount to the player who makes a hand of four-of-a-kind, a straight flush or a royal flush using his two cards in combination with the first three face-up community cards.

18. In the method of claim 1, paying or crediting a pre-determined bonus amount to the player who makes a poker hand of four-of-a-kind, a straight flush or a royal flush aces using his two cards in combination with the five face-up community cards.

19. In the method of claim 1, paying or crediting a pre-determined bonus amount to the player who makes a poker hand of four-of-a-kind, a straight flush or a royal flush using only one of his two cards in combination with the five face-up community cards.

20. In the method of claim 1:
Each player having the option to wager an optional same second bet amount for the bonus payout; and
Paying or crediting a pre-determined bonus amount to the players who placed the optional same second bet amount and who make a poker hand of a straight, a flush or a full-house using their two cards in combination with the first three face-up community cards.

21. In the method of claim 1:
Each player having the option to wager an optional same second bet amount for the bonus payout;
Paying or crediting a pre-determined bonus amount to the players who placed the optional same second bet amount and who make a poker hand of a straight, a flush or a full-house using his two cards in combination with the five face-up community cards.

22. A method for playing a poker game with a 52-card deck comprising cards numbered 2, 3, 4, 5, 6, 7, 8, 9, 10, jack, queen, king and ace in the suits of clubs, diamonds, hearts and spades; said method involving a dealer and a plurality N of players P1 to PN; said method comprising the steps of:
Each player P1 to PN wagering the same bet amount to create a pot;
Dealing in order a first card face-down to each player P1 to PN and to the dealer thereby resulting in a transformed deck with 52-(N+1) cards;
Dealing in order a second card face-down to each player P1 to PN and to the dealer thereby resulting in a transformed deck with 52-(N+1)-(N+1) cards;
Dealing in order a third card face-down to each player P1 to PN and to the dealer thereby resulting in a transformed deck with 52-(N+1)-(N+1)-(N+1) cards;
Dealing a first burn card face-down thereby resulting in a transformed deck with 52-(N+1)-(N+1)-(N+1)-1 cards;
Dealing three community cards face-up thereby resulting in a transformed deck with 52-(N+1)-(N+1)-(N+1)-1-3 cards;
Dealing a second burn card face-down thereby resulting in a transformed deck with 52-(N+1)-(N+1)-(N+1)-1-3-1 cards;
Dealing a fourth community card face-up thereby resulting in a transformed deck with 52-(N+1)-(N+1)-(N+1)-1-3-1-1 cards;
Dealing a third burn card face-down thereby resulting in a transformed deck with 52-(N+1)-(N+1)-(N+1)-1-3-1-1-1 cards;
Dealing a fifth community card face-up thereby resulting in a transformed deck with 52-(N+1)-(N+1)-(N+1)-1-3-1-1-1-1 cards;
Exposing face-up the three cards of each player P1 to PN and the dealer;
Determining the best poker hand for each player's two of his three cards and the best poker hand for the dealer's two of the dealer's three cards in combination with the five face-up community cards;
Paying or crediting the net pot amount to the player who makes the best poker hand higher than the dealer's best poker hand; or
Paying or crediting one-half of the net pot amount to the dealer should the dealer make the best poker hand higher than all of the players' best poker hands; and returning to each player one-half of each player's original bet amount.

23. A method for playing a poker game with a 52-card deck comprising cards numbered 2, 3, 4, 5, 6, 7, 8, 9, 10, jack, queen, king and ace in the suits of clubs, diamonds, hearts and spades; said method involving a dealer and a plurality N of players P1 to PN; said method comprising the steps of:
Each player P1 to PN wagering the same bet amount to create a pot;
Dealing in order a first card face-down to each player P1 to PN and to the dealer thereby resulting in a transformed deck with 52-(N+1) cards;
Dealing in order a second card face-down to each player P1 to PN and to the dealer thereby resulting in a transformed deck with 52-(N+1)-(N+1) cards;
Dealing in order a third card face-down to each player P1 to PN and to the dealer thereby resulting in a transformed deck with 52-(N+1)-(N+1)-(N+1) cards;
Dealing in order a fourth card face-down to each player P1 to PN and to the dealer thereby resulting in a transformed deck with 52-(N+1)-(N+1)-(N+1)-(N+1) cards;
Dealing a first burn card face-down thereby resulting in a transformed deck with 52-(N+1)-(N+1)-(N+1)-(N+1)-1 cards;
Dealing three community cards face-up thereby resulting in a transformed deck with 52-(N+1)-(N+1)-(N+1)-(N+1)-1-3 cards;
Dealing a second burn card face-down thereby resulting in a transformed deck with 52-(N+1)-(N+1)-(N+1)-(N+1)-1-3-1 cards;
Dealing a fourth community card face-up thereby resulting in a transformed deck with 52-(N+1)-(N+1)-(N+1)-(N+1)-1-3-1-1 cards;
Dealing a third burn card face-down thereby resulting in a transformed deck with 52-(N+1)-(N+1)-(N+1)-(N+1)-1-3-1-1-1 cards;
Dealing a fifth community card face-up thereby resulting in a transformed deck with 52-(N+1)-(N+1)-(N+1)-(N+1)-1-3-1-1-1-1 cards;
Exposing face-up the four cards of each player P1 to PN and the dealer;
Determining the best poker hand for each player's two of his four cards and the best poker hand for the dealer's two of the dealer's four cards in combination with three of the five face-up community cards;
Paying or crediting the next pot amount to the player making the best poker hand higher than the dealer's best poker hand; or
Paying or crediting one-half of the net pot amount to the dealer should the dealer make the best poker hand higher than all of the players' best poker hands; and returning to each player one-half of each player's original single bet amount.

24. A method for playing a poker game with a virtual 52-card deck comprising cards numbered 2, 3, 4, 5, 6, 7, 8, 9, 10, jack, queen, king and ace in the suits of clubs, diamonds, hearts and spades; said method involving a live dealer and a plurality N of players P1 to PNM; said method comprising the steps of:
Each player P1 to PN wagering the same bet amount to create a pot;
Utilizing a computer system to generate, assign, and display a first card face-down to each player and to the live dealer thereby leaving the virtual deck with 52-(N+1) cards;
Utilizing said computer system to generate, assign, and display a second card face-down to each player and to the live dealer thereby leaving the virtual deck with 52-(N+1)-(N+1) cards;
Utilizing said computer system to generate and display a first burn card face-down thereby leaving the virtual deck with 52-(N+1)-(N+1)-1 cards;
Utilizing said computer system to generate and display three community cards face-up thereby leaving the deck with 52-(N+1)-(N+1)-1-3 cards;
Utilizing said computer system to generate and display a second burn card face-down thereby leaving the virtual deck with 52-(N+1)-(N+1)-1-3-1 cards;
Utilizing said computer system to generate and display a fourth community card face-up thereby leaving the virtual deck with 52-(N+1)-(N+1)-1-3-1-1 cards;
Utilizing said computer system to generate and display a third burn card face-down thereby leaving the virtual deck with 52-(N+1)-(N+1)-1-3-1-1-1 cards;
Utilizing said computer system to generate and display a fifth community card face-up thereby leaving the virtual deck with 52-(N+1)-(N+1)-1-3-1-1-1-1 cards;
Utilizing said computer system to display face-up the two cards of each player P1 to PN and of the live dealer; and
Utilizing said computer system to determine and display the best poker hand for each player's two cards and the best poker hand for the live dealer's two cards in combination with the five face-up community cards.

25. A method for playing a poker game with a virtual 52-card deck comprising cards numbered 2, 3, 4, 5, 6, 7, 8, 9, 10, jack, queen, king and ace in the suits of clubs, diamonds, hearts and spades; said method involving a virtual dealer and a plurality N of players P1 to PN; said method comprising the steps of:
Each player P1 to PN wagering the same bet amount to create a pot;
Utilizing a computer system to generate, assign, and display a first card face-down to each player P1 to PN and to the virtual dealer thereby leaving the virtual deck with 52-(N+1) cards;
Utilizing said computer system to generate, assign, and display a second card face-down to each player P1 to PN and to the virtual dealer thereby leaving the virtual deck with 52-(N+1)-(N+1) cards;
Utilizing said computer system to generate and display a first burn card face-down thereby leaving the virtual deck with 52-(N+1)-(N+1)-1 cards;
Utilizing said computer system to generate and display three community cards face-up thereby leaving the virtual deck with 52-(N+1)-(N+1)-1-3 cards;
Utilizing said computer system to generate and display a second burn card face-down thereby leaving the virtual deck with 52-(N+1)-(N+1)-1-3-1 cards;
Utilizing said computer system to generate and display a fourth community card face-up thereby leaving the virtual deck with 52-(N+1)-(N+1)-1-3-1-1 cards;
Utilizing said computer system to generate and display a third burn card face-down thereby leaving the virtual deck with 52-(N+1)-(N+1)-1-3-1-1-1 cards;
Utilizing said computer system to generate and display a fifth community card face-up thereby leaving the virtual deck with 52-(N+1)-(N+1)-1-3-1-1-1-1 cards;
Utilizing said computer system to display face-up the two cards of each player and the virtual dealer; and
Utilizing said computer system to determine and display the best poker hand for each player's two cards and the best poker hand for the virtual dealer's two cards in combination with the five face-up community cards.
